(19) United States
(12) Patent Application Publication
(10) Pub. No.: US 2023/0150828 A1
(43) Pub. Date: May 18, 2023

(54) LITHIUM SULFIDE PRODUCTION METHOD

(71) Applicant: Solid Power Operating, Inc., Louisville, CO (US)

(72) Inventors: Brian E. FRANCISCO, Arvada, CO (US); Samuel Oberwetter, Lafayette, CO (US); Sean P. Culver, Broomfield, CO (US); Ilya Lisenker, Boulder, CO (US)

(21) Appl. No.: 17/988,665

(22) Filed: Nov. 16, 2022

Related U.S. Application Data
(60) Provisional application No. 63/264,137, filed on Nov. 16, 2021.

(51) Int. Cl. C01D 15/00

(52) U.S. Cl. CPC C01D 15/00; C01P 2002/72; C01P 2006/80

(57) ABSTRACT

A process for producing a low-cost water-reactive sulfide material includes reacting a substantially anhydrous first alkali metal salt, a substantially anhydrous first sulfide compound, and a substantially anhydrous first alkali metal hydrosulfide compound in a substantially anhydrous polar solvent, providing differential solubility for a substantially high solubility second sulfide and a substantially low solubility second alkali metal salt, and forming a mixture of the high solubility second sulfide, a second alkali metal hydrosulfide, and the low solubility second alkali metal salt; removing the low solubility second alkali metal salt to isolate the supernatant including the second sulfide, and separating the polar solvent from the second sulfide and the second alkali metal hydrosulfide followed by heating to produce the second sulfide. The present disclosure provides a scalable process for production of a high purity alkali metal sulfide that is essentially free of undesired contaminants.

### CROSS-REFERENCE TO RELATED APPLICATION

This application is related to and claims priority under 35 U.S.C. § 119 from U.S. Provisional Application No. 63/264,137, filed Nov. 16, 2021, entitled “Lithium Sulfide Production Method,” the entire contents of which are fully incorporated by reference herein for all purposes.

### BACKGROUND

In recent years, our reliance on rechargeable batteries to power our phones, computers, and cars has deepened dramatically. Also, there are increasing demands for batteries to contain more power, to last longer, and to be more economical. To meet these growing demands, companies and researches alike have focused on the solid state rechargeable battery, specifically those that contain solid state sulfide electrolytes.

One of the major reactants utilized in the synthesis of solid state sulfide electrolytes is Lithium Sulfide (Li₂S). As this compound does not occur naturally, it must be made synthetically and the traditional synthetic routes require expensive precursors, expensive equipment, and may result in compounds of low purity. For example, Smith (U.S. Pat. No. 3,642,436) teaches reacting alkali metals with hydrogen sulfide or sulfur vapor, but this method requires expensive high purity lithium metal and the use of large quantities of hydrogen sulfide, which is a highly toxic gas. Dawidowski (DE102012208982) teaches reacting a lithium metal base with hydrogen sulfide in an organic solvent; however, this method too employs expensive precursors in the form of lithium organic compounds. Barker (U.S. Pat. No. 8,377,411) and Mehta (U.S. Pat. No. 6,555,078) both teach processes that use less expensive precursors but Barker's method requires expensive specialized processing equipment due to the corrosive nature of the process and Mehta's method requires the use of high temperatures and an aqueous solution, which would lead to hydrolysis of the lithium sulfide and a lower purity product. In order to overcome these problems, a more efficient and lower cost method of producing Li₂S is necessary. The present disclosure provides a robust process to produce lithium sulfides of high purity using inexpensive precursors and scalable processes.

### SUMMARY

This application includes a method for producing a lithium sulfide compound of high purity where a lithium metal salt and a hydrosulfide-containing-compound react in a protic organic solvent where a substantial difference in solubility exists between the newly formed lithium metal hydrosulfide and alkali metal salt by-product. The resulting alkali metal salt by-product and the protic organic solvent is removed, and a heat treatment is administered to form a lithium sulfide material of high purity.

As used herein, the term “high purity” or “high level of purity” may mean at least 85% pure, at least 90% pure, at least 91% pure, at least 92% pure, at least 93% pure, at least 94% pure, at least 95% pure, at least 96% pure, at least 97% pure, at least 98% pure, at least 99% pure, or at least 99.5% pure.

In one embodiment, the method for producing a water-reactive alkali metal sulfide comprises (a) reacting a first alkali metal salt, a first sulfide, and a first alkali metal hydrosulfide in a polar solvent to produce a mixture of a second sulfide, a second alkali metal hydrosulfide, and a second alkali metal salt, wherein the polar solvent is selected so as to provide a solubility difference between the second sulfide, which is highly soluble in the polar solvent; the second alkali metal hydrosulfide, which is also highly soluble in the polar solvent; and the second alkali metal salt, which forms a precipitate in the polar solvent; (b) removing the precipitated second alkali metal salt from the mixture to produce a supernatant comprising the second sulfide, the second alkali metal hydrosulfide, and the polar solvent; and (c) heating the supernatant to remove the polar solvent, and to convert the second alkali metal hydrosulfide to the second sulfide.

In another embodiment, the method for producing a water-reactive alkali metal sulfide comprises (a) reacting a first alkali metal salt, a first sulfide, and a first alkali metal hydrosulfide in a polar solvent to produce a mixture of a second sulfide, a second alkali metal hydrosulfide, and the first alkali metal salt, wherein the polar solvent is selected so as to provide a solubility difference between the second sulfide, which is highly soluble in the polar solvent; the second alkali metal hydrosulfide, which is also highly soluble in the polar solvent; and the first alkali metal salt, which forms a precipitate in the polar solvent; (b) removing the precipitated first alkali metal salt from the mixture to produce a supernatant comprising the second sulfide, the second alkali metal hydrosulfide, and the polar solvent; and (c) heating the supernatant to remove the polar solvent, and to convert the second alkali metal hydrosulfide to the second sulfide.

In another embodiment, the method comprises reacting a first alkali metal salt and a first alkali metal hydrosulfide to produce a second alkali metal salt and a first alkali metal sulfide (e.g., LiCl+NaSH→Li₂S+NaCl). The method may further comprise isolating the first alkali metal sulfide at a high level of purity.

In another embodiment, the method comprises reacting a first alkali metal salt and a first alkali metal hydrosulfide to produce a second alkali metal salt, a second alkali metal hydrosulfide, and a first alkali metal sulfide (e.g., LiCl+NaSH→Li₂S+LiSH+NaCl). The method may further comprise isolating the first alkali metal sulfide at a high level of purity.

In another embodiment, the method comprises reacting a first alkali metal salt and a first alkali metal hydrosulfide to produce a first alkali metal salt, a second alkali metal salt and a second alkali metal sulfide (e.g., LiCl+NaSH→Li₂S+LiCl+NaCl). The method may further comprise isolating the first alkali metal sulfide, the first alkali metal salt, and/or the second alkali metal salt at a high level of purity, individually or collectively.

In another embodiment, the method comprises reacting a first alkali metal salt, a first alkali metal sulfide, and a first alkali metal hydrosulfide to produce a second alkali metal salt and a second alkali metal sulfide (e.g., LiCl+Na₂S+NaSH→Li₂S+NaCl). The method may further comprise isolating the first alkali metal sulfide at a high level of purity.

In another embodiment, the method comprises reacting a first alkali metal salt, a first alkali metal sulfide, and a first alkali metal hydrosulfide to produce a first alkali metal salt, a second alkali metal salt and a second alkali metal sulfide (e.g., LiCl+Na₂S+NaSH→Li₂S+LiCl+NaCl). The method may further comprise isolating the first alkali metal sulfide, the first alkali metal salt, and/or the second alkali metal salt at a high level of purity, individually or collectively.

In another embodiment, the method for producing a water-reactive alkali metal sulfide comprises (a) reacting a first alkali metal salt, a first sulfide, and a first alkali metal hydrosulfide hydrate in a solvent to produce a reaction mixture, (b) heating the reaction mixture; and (c) isolating a purified second sulfide and a purified first alkali metal salt. The solvent may be a hydrocarbon solvent (e.g., a non-polar hydrocarbon solve), a polar solvent (e.g., a polar organic solvent), or a combination thereof. The purified second sulfide may be Li₂S and a purified first alkali metal salt may be LiCl. The second sulfide and/or first alkali metal salt may optionally be recycled as reactants, e.g., to further increase the purity of the purified second sulfide and purified first alkali metal salt final products. The reaction mixture may be heated to about 100° C. to about 150° C., to about 150° C. to about 200° C., to about 200° C. to about 250° C., at about 250° C. to about 300° C., at about 300° C. to about 350° C., at about 350° C. to about 400° C., at about 400° C. to about 450° C.

In another embodiment, the method for producing a water-reactive alkali metal sulfide comprises (a) reacting a first alkali metal salt, a first sulfide, a second sulfide and a first alkali metal hydrosulfide hydrate in a solvent to produce a reaction mixture, (b) heating the reaction mixture; and (c) isolating a third sulfide and a purified first alkali metal salt. The solvent may be a hydrocarbon solvent, a polar solvent (e.g., a polar organic solvent), or a combination thereof. The purified third sulfide may be Li₂S and the purified first alkali metal salt may be LiCl. The third sulfide and/or first alkali metal salt may optionally be recycled as reactants, e.g., to further increase the purity of the purified third sulfide and purified first alkali metal salt final products. The reaction mixture may be heated to about 100° C. to about 150° C., at about 150° C. to about 200° C., at about 200° C. to about 250° C., at about 250° C. to about 300° C., at about 300° C. to about 350° C., at about 350° C. to about 400° C., at about 400° C. to about 450° C.

In yet another embodiment, the method for producing a water-reactive alkali metal sulfide comprises (a) reacting a first alkali metal salt, a second alkali metal salt, a first sulfide, a first alkali metal hydrosulfide hydrate in a solvent to produce a reaction mixture, (b) heating the reaction mixture; and (c) isolating a second sulfide and a purified first alkali metal salt. The solvent may be a hydrocarbon solvent, a polar solvent (e.g., a polar organic solvent), or a combination thereof. The purified second sulfide may be Li₂S and the purified first alkali metal salt may be LiCl. In this reaction, the solubility difference between the first alkali metal salt and the second alkali metal salt results in a substantially increase in purity of the first alkali metal salt product. The second sulfide and/or first alkali metal salt may optionally be recycled as reactants, e.g., to further increase the purity of the purified second sulfide and purified first alkali metal salt final products. The reaction mixture may be heated to about 100° C. to about 150° C., at about 150° C. to about 200° C., at about 200° C. to about 250° C., at about 250° C. to about 300° C., at about 300° C. to about 350° C., at about 350° C. to about 400° C., at about 400° C. to about 450° C.

In another embodiment, the method of claim further comprises heating the second sulfide after the polar solvent is removed. In some aspects, the heating comprises sintering.

In another embodiment, the method further comprises adding a sulfur source so as to increase purity of the second sulfide. The sulfur source comprises one or more of elemental sulfur and H₂S. The sulfur source may be added at any step of the method prior to or during heating of the supernatant.

In yet another embodiment of the method, the second sulfide further comprises a Li₃OCl contaminant which may be subsequently removed by the sulfur source addition and a subsequent heat treatment step. In yet another embodiment of the method, the second sulfide further comprises a Li₃OCl contaminant which may be subsequently removed by the sulfur source addition and a subsequent heat treatment step, wherein the Li₃OCl contaminant content is less than 25%, 20%, 15%, 10%, 7%, 5%, 4%, 3%, 2%, or 1% by weight. In yet another embodiment of the method, the second sulfide further comprises a Li₃OCl contaminant which may be subsequently removed by the sulfur source addition and a subsequent heat treatment step, wherein the Li₃OCl contaminant content is less than 25%, 20%, 15%, 10%, 7%, 5%, 4%, 3%, 2%, 1% or 0.5% after the heat treatment step.

In yet another embodiment of the method, the second sulfide further comprises a LiHS contaminant which may be subsequently removed by a heating step. In yet another embodiment of the method, the second sulfide further comprises a LiHS contaminant which may be subsequently removed by the sulfur source addition and a subsequent heat treatment step, wherein the LiHS contaminant content is less than 25%, 20%, 15%, 10%, 7%, 5%, 4%, 3%, 2%, or 1% by weight. In yet another embodiment of the method, the second sulfide further comprises a LiHS contaminant which may be subsequently removed by the sulfur source addition and a subsequent heat treatment step, wherein the LiHS contaminant content is less than 25%, 20%, 15%, 10%, 7%, 5%, 4%, 3%, 2%, 1% or 0.5% by weight after the heat treatment step. The combined Li₃OCl and LiHS contaminant may be less than 40%, 35%, 30%, 25%, 20%, 15%, 10%, 7%, 5%, 4%, 3%, 2%, 1% or 0.5% by weight after the heat treatment step.

In yet another embodiment, the method further comprises introducing an anti-solvent compound to the supernatant prior to or directly following the precipitation of the second alkali metal salt.

In yet another embodiment of the method, the removing of the second alkali metal salt from the supernatant comprises at least one of centrifuging, filtering, gravity settling, and cooling.

In another embodiment, the method further comprises reducing an amount of the polar solvent from the supernatant, wherein reducing comprises at least one of evaporating the polar solvent, heating the polar solvent, or reducing atmospheric pressure surrounding the supernatant.

In another embodiment, the method further comprises manipulating relative amounts of the first alkali metal salt, the first sulfide compound, and the first alkali metal hydrosulfide compound so as to increase purity of the second sulfide.

In yet another embodiment of the method, the polar solvent is substantially anhydrous. The polar solvent may be at least one alcohol selected from the group consisting of ethanol, 1-propanol, 1-butanol, and mixtures thereof.

In yet another embodiment of the method, the anti-solvent is selected from one or more hydrocarbon-based solvent, including but not limited to alkanes (e.g., pentane, hexane, heptane, decane, undecane), cyclic alkanes, xylene, and/or toluene.

In yet another embodiment of the method, the anti-solvent is selected from one or more of heptane and other non-polar solvents with substantial miscibility in the polar solvent and which increase the differential solubility of one or more of the second sulfide and second alkali metal hydrosulfide in the polar solvent in comparison to the second alkali metal salt.

In yet another embodiment of the method, the first alkali metal salt comprises LiCl, the first alkali metal hydrosulfide comprises NaHS and/or NaHS•XH₂O, and the first sulfide comprises Na₂S.

In yet another embodiment of the method, the second alkali metal salt comprises NaCl, the second alkali metal hydrosulfide comprises LiHS, and the second sulfide comprises Li₂S.

In yet another embodiment of the method, the first alkali metal salt and the first sulfide are separately dissolved in aliquots of the polar solvent, which separate aliquots are then combined to form a mixture prior to adding the first alkali metal hydrogen sulfide.

In yet another embodiment of the method, the first alkali metal salt, the first sulfide compound, and the first alkali metal hydrosulfide are independently dissolved in the polar solvent prior to reacting them together.

In yet another embodiment of the method, the first alkali metal salt or the first sulfide is first dissolved in the polar solvent then the other is added in solid form.

In yet another embodiment of the method, one of the first alkali metal salt, the first sulfide, and the alkali metal hydrosulfide is dissolved in the polar solvent and the others are added to the solution in solid form.

In yet another embodiment of the method, the ratio of the solubility of the second sulfide to the solubility of the second alkali metal salt in the polar solvent is at least 90:10. In yet another embodiment, the ratio of the solubility of the second sulfide to the solubility of the second alkali metal salt in the polar solvent is at least 97:3. In yet another embodiment, the ratio of the solubility of the second sulfide to the solubility of the second alkali metal salt in the polar solvent is at least 99:1. In yet another embodiment, the ratio of the solubility of the second sulfide to the solubility of the second alkali metal salt in the polar solvent is at least 99.9:0.1.

In yet another embodiment, the first sulfide compound is selected from the group consisting of K₂S, Na₂S, (NH₄)₂S, and mixtures thereof.

In yet another embodiment, the first alkali metal hydrosulfide compound is selected from the group consisting of KHS, NaHS, LiHS, and mixtures thereof.

In yet another embodiment, the second sulfide comprises Li₂S.

In yet another embodiment, the second sulfide comprises a purity of 95% or greater.

In yet another embodiment, the second sulfide has a mass loss of less than 13% when heated above 340° C.

In another embodiment, this disclosure describes a solid electrolyte comprising a second sulfide produced by a method for producing a water-reactive alkali metal sulfide, which comprises (a) reacting a first alkali metal salt, a first sulfide, and a first alkali metal hydrosulfide in a polar solvent to produce a mixture of a second sulfide, a second alkali metal hydrosulfide, and a second alkali metal salt, wherein the polar solvent is selected so as to provide a solubility difference between the second sulfide, which is highly soluble in the polar solvent; the second alkali metal hydrosulfide, which is also highly soluble in the polar solvent; and the second alkali metal salt, which forms a precipitate in the polar solvent; (b) removing the precipitated second alkali metal salt from the mixture to produce a supernatant comprising the second sulfide, the second alkali metal hydrosulfide, and the polar solvent; and (c) heating the supernatant to remove the polar solvent, and to convert the second alkali metal hydrosulfide to the second sulfide.

In another embodiment, the second sulfide is Li₂S.

In another embodiment, the alkali metal hydrosulfide is LiHS.

In another embodiment, the alkali metal hydrosulfide is NaHS•XH₂O (e.g., a hydrate).

In another embodiment, the first alkali metal salt comprises LiX, wherein X is a halogen.

In another embodiment, the second sulfide is Li₂S, the first alkali metal hydrosulfide is LiHS or NaHS•XH₂O, and the first alkali metal salt comprises a lithium halide (e.g., one or more of LiCl, LiBr, LiI). The purified first alkali metal salt may be over 94% pure, over 95% pure, over 96% pure, over 97% pure, over 98% pure, over 98.5% pure, over 99% pure, over 99.5% pure.

In another embodiment, this disclosure describes a solid state battery comprising the second sulfide produced by a method for producing a water-reactive alkali metal sulfide, which comprises (a) reacting a first alkali metal salt, a first sulfide, and a first alkali metal hydrosulfide in a polar solvent to produce a mixture of a second sulfide, a second alkali metal hydrosulfide, and a second alkali metal salt, wherein the polar solvent is selected so as to provide a solubility difference between the second sulfide, which is highly soluble in the polar solvent; the second alkali metal hydrosulfide, which is also highly soluble in the polar solvent; and the second alkali metal salt, which forms a precipitate in the polar solvent; (b) removing the precipitated second alkali metal salt from the mixture to produce a supernatant comprising the second sulfide, the second alkali metal hydrosulfide, and the polar solvent; and (c) heating the supernatant to remove the polar solvent, and to convert the second alkali metal hydrosulfide to the second sulfide.

In another embodiment, the second sulfide is Li₂S.

In another embodiment, this disclosure describes a vehicle powered by a battery comprising the second sulfide produced by a method for producing a water-reactive alkali metal sulfide, which comprises (a) reacting a first alkali metal salt, a first sulfide, and a first alkali metal hydrosulfide in a polar solvent to produce a mixture of a second sulfide, a second alkali metal hydrosulfide, and a second alkali metal salt, wherein the polar solvent is selected so as to provide a solubility difference between the second sulfide, which is highly soluble in the polar solvent; the second alkali metal hydrosulfide, which is also highly soluble in the polar solvent; and the second alkali metal salt, which forms a precipitate in the polar solvent; (b) removing the precipitated second alkali metal salt from the mixture to produce a supernatant comprising the second sulfide, the second alkali metal hydrosulfide, and the polar solvent; and (c) heating the supernatant to remove the polar solvent, and to convert the second alkali metal hydrosulfide to the second sulfide.

In another embodiment, the second sulfide is Li₂S. The second sulfide may be over 94% pure, over 95% pure, over 96% pure, over 97% pure, over 98% pure, over 98.5% pure, over 99% pure, over 99.5% pure and/or substantially free from lithium oxides (i.e., ≤6.0%, ≤5.0%, ≤4.0%, ≤3.0%, ≤2.0%, ≤1.5%, ≤1.0%, or ≤0.5% lithium oxides).

In another embodiment, this disclosure describes a method for producing lithium sulfide comprising reacting substantially anhydrous LiCl, a substantially anhydrous sulfide compound selected from Na₂S and K₂S, and a substantially anhydrous hydrosulfide compound selected from LiHS, NaHS and KHS in a solvent selected from the group consisting of ethanol, 1-propanol and 1-butanol to produce a high solubility Li₂S alkali metal sulfide and optionally a high solubility LiHS alkali metal hydrosulfide and low solubility alkali metal salt; separating a supernatant comprising the high solubility Li₂S alkali metal sulfide and, when present, the high solubility LiHS alkali metal hydrosulfide, and the solvent, and a precipitate comprising a low solubility alkali metal salt; and evaporating the solvent from the supernatant to produce isolated Li₂S and LiHS.

In another embodiment, this disclosure describes a method for producing lithium sulfide (Li₂S) comprising reacting a lithium halide (e.g., LiCl), a sulfide compound selected from Na₂S and/or K₂S, and a compound selected from LiHS•XH₂O, NaHS•XH₂O, and/or KHS•XH₂O in a solvent selected from the group consisting of ethanol, 1-propanol and 1-butanol to produce a high solubility Li₂S alkali metal sulfide and high solubility LiHS alkali metal hydrosulfide and low solubility alkali metal salt; separating a supernatant comprising the high solubility Li₂S alkali metal sulfide and high solubility LiHS alkali metal hydrosulfide and the solvent, and a precipitate comprising a low solubility alkali metal salt; and evaporating the solvent from the supernatant to produce isolated Li₂S and LiCl.

In another embodiment, the method further comprises heating the isolated Li₂S and LiHS to a temperature at which LiHS is converted to Li₂S and H₂S.

In another embodiment, the method further comprises adding a sulfur source. The sulfur source comprises one or more of elemental sulfur and H₂S.

In another embodiment, the method further comprises introducing an anti-solvent compound to the supernatant of the high solubility alkali metal sulfide, high solubility alkali metal hydrosulfide and the polar solvent, directly following the precipitation of the low solubility alkali metal salt by-product, wherein the anti-solvent is selected from one or more of heptane and other non-polar solvents with substantial miscibility in the polar solvent and which increases the differential solubility of the alkali metal sulfide versus the by-products.

Further provided herein is a method for producing a water-reactive alkali metal sulfide. The method generally comprises reacting a first alkali metal salt and a first alkali metal hydrosulfide and optionally a first sulfide in a polar solvent to produce a mixture comprising a second sulfide and a second alkali metal salt precipitate; removing the precipitated second alkali metal salt from the mixture to produce a supernatant comprising the second sulfide and the polar solvent; and removing the polar solvent from the supernatant. Also provided herein is a solid state electrolyte comprising the second sulfide produced by this method.

In another embodiment, the removing the polar solvent from the supernatant comprises evaporating the polar solvent to produce a powder. In some aspects, the evaporating comprises drying the powder to remove substantially all of the polar solvent. In some additional aspects, over 99% by weight of the polar solvent from the powder is removed.

In another embodiment, the removing the polar solvent from the supernatant comprises spray drying, rotary drying, tray drying, fluidized bed drying, vacuum drying, or a combination thereof.

In another embodiment, the method further comprises adding a sulfur source to increase the purity of the second sulfide. In some aspects, the sulfur source comprises one or more of elemental sulfur and H₂S. In some additional aspects, the sulfur source is added at any step of the method prior to or during the removing of the polar solvent from the supernatant. In still further aspects, the second sulfide is at least 95% free by weight from Li₃OCl contaminant.

In another embodiment, the supernatant further comprises a second alkali metal hydrosulfide. In some aspects, the method comprises heating the second alkali metal hydrosulfide to produce the second sulfide and hydrogen sulfide. In some additional aspects, the second alkali metal hydrosulfide comprises LiHS.

In another embodiment, the method further comprises introducing an anti-solvent compound to the supernatant prior to or directly following the precipitation of the second alkali metal salt. In some aspects, the anti-solvent is selected from the group consisting of hydrocarbon-based solvents, non-polar solvents, solvents with substantial miscibility in the polar solvent, solvents that increase the differential solubility of one or more of the second sulfide and second alkali metal hydrosulfide in the polar solvent in comparison to the second alkali metal salt, and combinations thereof.

In some aspects, removing the second alkali metal salt from the supernatant comprises at least one of centrifuging, filtering, gravity settling, and cooling.

In another embodiment, the method further comprises reducing an amount of the polar solvent from the supernatant, wherein reducing comprises at least one of evaporating the polar solvent, heating the polar solvent, or reducing atmospheric pressure surrounding the supernatant.

In another embodiment, the method further comprises increasing the relative amount of the first alkali metal salt, the first sulfide compound, or the first alkali metal hydrosulfide compound to increase purity of the second sulfide to greater than 95% by weight.

In another embodiment, the polar solvent is substantially anhydrous. In some additional embodiments, the polar solvent comprises at least one alcohol selected from the group consisting of ethanol, 1-propanol, 1-butanol, and mixtures thereof.

In another embodiment, the first alkali metal hydrosulfide is substantially anhydrous.

In another embodiment, the ratio of masses of the first alkali metal hydrosulfide and the water incorporated therein is greater than 2:1. In some additional embodiments, the ratio of masses of the first alkali metal hydrosulfide and the water incorporated therein is greater than 3:1. In still further embodiments, the ratio of masses of the first alkali metal hydrosulfide and the water incorporated therein is greater than 4:1.

In another embodiment, the first alkali metal salt comprises LiCl, the first alkali metal hydrosulfide comprises NaHS, and the first sulfide comprises Na₂S.

In another embodiment, the second alkali metal salt comprises NaCl and the second sulfide comprises Li₂S.

In another embodiment, the first alkali metal salt and the first sulfide are separately dissolved in aliquots of the polar solvent, which separate aliquots are then combined to form a mixture prior to adding the first alkali metal hydrogen sulfide.

In another embodiment, the first alkali metal salt, the first sulfide compound, and the first alkali metal hydrosulfide are independently dissolved in the polar solvent prior to reacting them together.

In another embodiment, the first alkali metal salt or the first sulfide is first dissolved in the polar solvent then the other is added in solid form.

In another embodiment, one of the first alkali metal salt, the first sulfide, and the first alkali metal hydrosulfide is dissolved in the polar solvent and the others are added to the solution in solid form.

In another embodiment, the ratio of the solubility of the second sulfide to the solubility of the second alkali metal salt in the polar solvent is at least 90:10. In some additional embodiments, the ratio of the solubility of the second sulfide to the solubility of the second alkali metal salt in the polar solvent is at least 97:3. In still further embodiments, the ratio of the solubility of the second sulfide to the solubility of the second alkali metal salt in the polar solvent is at least 99:1. In still further embodiments, the ratio of the solubility of the second sulfide to the solubility of the second alkali metal salt in the polar solvent is at least 99.9:0.1.

In another embodiment, the first sulfide compound is selected from the group consisting of K₂S, Na₂S, (NH₄)₂S, and mixtures thereof.

In another embodiment, the first alkali metal hydrosulfide compound is selected from the group consisting of KHS, NaHS, LiHS, and mixtures thereof.

In another embodiment, the second sulfide comprises Li₂S. In some additional embodiments, the second sulfide comprises a purity of 95% or greater. In still further embodiments, the second sulfide has a mass loss of less than 10% when heated above 100° C. In still further embodiments, the second sulfide has a mass loss of less than 13% when heated above 340° C.

In another embodiment, the produced mixture further comprises LiNaS. In some additional embodiments, the produced mixture further comprises Li₂MgS₂. In still further embodiments, the produced mixture further comprises Li₂CaS₂.

In another embodiment, the second sulfide is about 97.5% to about 99.9% free by weight from Na₂S2O₃ contaminant. In yet another embodiment, the second sulfide is about 97.5% to about 99.9% free by weight from Na₂S₂ contaminant.

Further provided herein is a method for producing a water-reactive alkali metal sulfide. The method comprises reacting a first alkali metal salt and a first alkali metal hydrosulfide in a polar solvent to produce a mixture comprising a sulfide and a second alkali metal salt precipitate; removing the precipitated second alkali metal salt from the mixture to produce a supernatant comprising the sulfide and the polar solvent; and removing the polar solvent from the supernatant.

Further provided herein is a method for producing lithium sulfide. The method comprises reacting LiCl, a first alkali metal hydrosulfide, and optionally a first sulfide comprising one or more of Na₂S, K₂S, and (NH₄)₂S, in a solvent comprising one or more polar solvent to produce a mixture comprising Li₂S and an alkali metal salt. The mixture may comprise NaCl as a precipitate and dissolved LiCl. In some embodiments, the method further comprises separating a supernatant comprising the Li₂S. Additionally provided herein is a solid state electrolyte comprising Li₂S produced by this method. Also provided herein is a solid state electrolyte comprising LiCl produced by this method.

In another embodiment, the method further comprises removing the solvent from the Li₂S, the alkali metal salt, or both the Li₂S and the alkali metal salt. In some aspects, the removing the solvent comprises evaporating the solvent to produce a powder. In some particular aspects, the removing the solvent comprises spray drying, rotary drying, tray drying, fluidized bed drying, vacuum drying, or a combination thereof.

In another embodiment, the polar solvent comprises ethanol, 1-propanol, 1-butanol, or a combination thereof.

In another embodiment, the first alkali metal hydrosulfide comprises LiHS, NaHS, KHS, or a combination thereof.

In another embodiment, the first alkali metal hydrosulfide comprises NaHS. In some additional embodiments, the first alkali metal hydrosulfide is substantially anhydrous.

In another embodiment, the LiCl is substantially anhydrous. In some additional embodiments, the LiCl comprises about 100 ppm to about 1500 ppm H₂O content. In still further embodiments, the LiCl comprises about 900 ppm to about 1100 ppm H₂O content.

In another embodiment, the first sulfide is substantially anhydrous. In some additional embodiments, the first sulfide comprises about 100 ppm to about 1500 ppm H₂O content. In still further embodiments, the first sulfide comprises about 900 ppm to about 1100 ppm H₂O content.

In another embodiment, the mixture and the supernatant comprises a second alkali metal hydrosulfide.

In another embodiment, the method further comprises introducing an anti-solvent to the supernatant. In some aspects, the anti-solvent comprises a hydrocarbon-based solvent, a non-polar solvent, or a combination thereof.

In another embodiment, the method further comprises adding a sulfur source. In some aspects, the sulfur source comprises one or more of elemental sulfur and H₂S.

In another embodiment, the ratio of masses of the first alkali metal hydrosulfide and the water incorporated therein is greater than 2:1. In some additional embodiments, the ratio of masses of the first alkali metal hydrosulfide and the water incorporated therein is greater than 3:1. In still further embodiments, the ratio of masses of the first alkali metal hydrosulfide and the water incorporated therein is greater than 4:1.

In another embodiment, the produced alkali metal salt comprises LiCl.

In another embodiment, the mixture comprises ≥5% LiCl by mass. In some additional embodiments, the mixture comprises ≥10% LiCl by mass.

In another embodiment, the mixture comprises at least 95% Li₂S and LiCl by mass, collectively. In some additional embodiments, the mixture comprises at least 98% Li₂S and LiCl by mass, collectively.

In another embodiment, Li₂S+LiCl are produced at ≥95% purity, individually. In some additional embodiments, Li₂S+LiCl are produced at ≥98% yield, collectively.

Further provided herein is a method for producing lithium sulfide. The method comprises reacting LiX, a first alkali metal hydrosulfide, and optionally a first sulfide comprising one or more of Na₂S, K₂S, and (NH₄)₂S, in a solvent comprising one or more polar solvent to produce a mixture comprising Li₂S and an alkali metal salt, wherein X is halogen.

In another embodiment, the produced alkali metal salt comprises LiX.

In another embodiment, the mixture comprises ≥5% LiX by mass. In still another embodiment, the mixture comprises ≥10% LiX by mass. In still further embodiments, the mixture comprises at least 95% Li₂S and LiX by mass, collectively. In still further embodiments, the mixture comprises at least 98% Li₂S and LiX by mass, collectively.

In another embodiment, Li₂S+LiX are produced at ≥95% purity, individually. In still another embodiment, Li₂S+LiX are produced at ≥98% purity, individually.

Further provided herein is a method for producing lithium sulfide. The method generally comprises reacting LiX and a first alkali metal hydrosulfide comprising one or more of Na₂S, K₂S, and (NH₄)₂S, in a solvent comprising one or more polar solvent to produce a mixture comprising Li₂S and an alkali metal salt.

Further provided herein is a method for producing a water-reactive alkali metal sulfide. The method comprises reacting a first alkali metal salt and a first alkali metal hydrosulfide and optionally a first sulfide in a polar solvent to produce a mixture comprising a second sulfide and a second alkali metal salt precipitate, wherein the first sulfide comprises an alkali or alkali earth metal impurity and the impurity is not lithium; removing the precipitated second alkali metal salt from the mixture to produce a supernatant comprising the second sulfide and the polar solvent; and, removing the polar solvent from the supernatant to produce a second sulfide.

In another embodiment, the first sulfide comprises an alkali or alkali earth metal impurity selected from the group consisting of sodium, magnesium, potassium, calcium, or a combination thereof.

In another embodiment, the first sulfide comprises lithium and an alkali or alkali earth metal impurity selected from the group consisting of sodium, magnesium, potassium, calcium, or a combination thereof.

In another embodiment, the second sulfide is at least 90% free of alkali metal or alkali earth metal impurities. In further embodiments, the second sulfide is at least 95% free of alkali metal or alkali earth metal impurities. In still further embodiments, the second sulfide is at least 98% free of alkali metal or alkali earth metal impurities. In still further embodiments, the second sulfide is at least 99% free of alkali metal or alkali earth metal impurities. In still further embodiments, the second sulfide is at least 99.5% free of alkali metal or alkali earth metal impurities. In still further embodiments, the second sulfide is at least 99.9% free of alkali metal or alkali earth metal impurities.

In another embodiment, the removing the polar solvent from the supernatant comprises evaporating the polar solvent to produce a powder. In some aspects, the evaporating comprises drying the powder to remove substantially all of the polar solvent. In some particular aspects, the removing the polar solvent comprises spray drying, rotary drying, tray drying, fluidized bed drying, vacuum drying, or a combination thereof. In some additional aspects, over 80% by weight of the polar solvent from the powder is removed. In still further aspects, over 99% by weight of the polar solvent from the powder is removed.

In another embodiment, the method further comprises adding a sulfur source to increase the purity of the second sulfide. In some aspects, the sulfur source comprises one or more of elemental sulfur and H₂S.

In another embodiment, the second sulfide is at least 95% pure by weight. In still other embodiments, the second sulfide is at least 98% pure by weight. In further embodiments, the second sulfide is at least 99% pure by weight. In still further embodiments, the second sulfide is at least 99.5% pure by weight.

In another embodiment, the supernatant further comprises a second alkali metal hydrosulfide. In some aspects, the second alkali metal hydrosulfide produces the second sulfide and hydrogen sulfide. In some additional aspects, the second alkali metal hydrosulfide comprises LiHS.

In another embodiment, the method further comprises adding an anti-solvent compound to the supernatant. In some aspects, the anti-solvent comprises a hydrocarbon-based solvent, a non-polar solvent, or combinations thereof.

In another embodiment, the method further comprises removing the second alkali metal salt from the supernatant comprises at least one of centrifuging, filtering, gravity settling, and cooling.

In another embodiment, the polar solvent is substantially anhydrous. In another embodiment, the polar solvent comprises at least one alcohol selected from the group consisting of ethanol, 1-propanol, 1-butanol, and mixtures thereof.

In another embodiment, the first alkali metal hydrosulfide is substantially anhydrous.

In another embodiment, the first alkali metal salt comprises LiCl, the first alkali metal hydrosulfide comprises NaHS, and the first sulfide comprises Na₂S.

In another embodiment, the second alkali metal salt comprises NaCl and the second sulfide comprises Li₂S.

In another embodiment, the optional first sulfide is selected from the group consisting of K₂S, Na₂S, (NH₄)₂S, and mixtures thereof. In another embodiment, the optional first sulfide comprises Li₂S.

In another embodiment, the first alkali metal hydrosulfide compound is selected from the group consisting of KHS, NaHS, LiHS, and mixtures thereof.

In another embodiment, the second sulfide comprises Li₂S.

Further provided herein is a method for producing a water-reactive alkali metal sulfide. The method comprises reacting a first alkali metal salt and a first alkali metal hydrosulfide and a first sulfide in a polar solvent to produce a mixture comprising a second sulfide and a second alkali metal salt precipitate, wherein the first sulfide comprises an oxygen impurity, a halide impurity, or a combination thereof; removing the precipitated second alkali metal salt from the mixture to produce a supernatant comprising the second sulfide and the polar solvent; and, removing the polar solvent from the supernatant to produce a second sulfide.

In another embodiment, the first sulfide comprises a halide impurity selected from the group consisting of chloride, bromide, iodide, fluoride, or a combination thereof.

In another embodiment, the first sulfide comprises an oxygen impurity selected from the group consisting of a carbonate, sulfate, hydroxide, oxide, or combination thereof.

In another embodiment, the second sulfide is at least 90% free of halide impurity. In yet another embodiment, the second sulfide is at least 95% free of halide impurity. In yet another embodiment, the second sulfide is at least 98% free of halide impurity. In yet another embodiment, the second sulfide is at least 99% free of halide impurity. In yet another embodiment, the second sulfide is at least 99.5% free of halide impurity. In yet another embodiment, the second sulfide is at least 99.9% free of halide impurity.

In another embodiment, the second sulfide is at least 90% free of oxide impurity. In yet another embodiment, the second sulfide is at least 95% free of oxide impurity. In yet another embodiment, the second sulfide is at least 98% free of oxide impurity. In yet another embodiment, the second sulfide is at least 99% free of oxide impurity. In yet another embodiment, the second sulfide is at least 99.5% free of oxide impurity. In yet another embodiment, the second sulfide is at least 99.9% free of oxide impurity.

In another embodiment, the second sulfide is at least 90% free of impurity. In yet another embodiment, the second sulfide is at least 95% free of impurity. In yet another embodiment, the second sulfide is at least 98% free of impurity. In yet another embodiment, the second sulfide is at least 99% free of impurity. In yet another embodiment, the second sulfide is at least 99.5% free of impurity. In yet another embodiment, the second sulfide is at least 99.9% free of impurity.

Further provided herein is a method for producing a water-reactive alkali metal sulfide. The method comprises reacting a first alkali metal salt and a first sulfide in a polar solvent to produce a mixture comprising a second sulfide and a second alkali metal salt precipitate; removing the precipitated second alkali metal salt from the mixture to produce a supernatant comprising the second sulfide and the polar solvent; and, removing the polar solvent from the supernatant to produce a second sulfide.

Further provided herein is a method for producing a water-reactive alkali metal sulfide. The method generally comprises reacting a first alkali metal salt and a first alkali metal hydrosulfide in a polar solvent to produce a mixture comprising a sulfide and a second alkali metal salt precipitate, wherein the first alkali metal salt comprises an alkali or alkali earth metal impurity and the impurity is not lithium; removing the precipitated second alkali metal salt from the mixture to produce a supernatant comprising sulfide and the polar solvent; and, removing the polar solvent from the supernatant to produce the sulfide.

Further provided herein is a method for producing a water-reactive alkali metal sulfide. The method generally comprises reacting a first alkali metal salt and a first alkali metal hydrosulfide and optionally a first sulfide in a polar solvent to produce a mixture comprising a second sulfide and a second alkali metal salt, wherein the first alkali metal salt comprises an alkali or alkali earth metal impurity and the impurity is not lithium; and removing the polar solvent to isolate the second sulfide and/or the second alkali metal salt.

In another embodiment, the first alkali metal salt comprises lithium and an alkali or alkali earth metal impurity selected from the group consisting of sodium, magnesium, potassium, calcium, or a combination thereof.

In another embodiment, the second sulfide is at least 90% free of alkali metal or alkali earth metal impurities. In still another embodiment, the second sulfide is at least 95% free of alkali metal or alkali earth metal impurities. In yet another embodiment, the second sulfide is at least 98% free of alkali metal or alkali earth metal impurities. In yet another embodiment, the second sulfide is at least 99% free of alkali metal or alkali earth metal impurities. In yet another embodiment, the second sulfide is at least 99.5% free of alkali metal or alkali earth metal impurities.

Further provided herein is a method for producing a water-reactive alkali metal sulfide. The method generally comprises reacting a first alkali metal salt and a first alkali metal hydrosulfide and optionally a first sulfide in a polar solvent to produce a mixture comprising a second sulfide and a second alkali metal salt precipitate, wherein the first alkali metal salt comprises an alkali or alkali earth metal impurity and the impurity is not lithium; removing the precipitated second alkali metal salt and optionally one or more alkaline earth metal sulfides from the mixture to produce a supernatant comprising the second sulfide and the polar solvent; and, removing the polar solvent from the supernatant to produce a second sulfide.

Further provided herein is a method for producing a water-reactive alkali metal sulfide. The method generally comprises reacting a first alkali metal salt and a first alkali metal hydrosulfide and optionally a first sulfide in a polar solvent to produce a mixture comprising a second sulfide, a second alkali metal salt, a third sulfide and the first alkali metal salt, wherein the first alkali metal salt comprises an alkali or alkali earth metal impurity and the impurity is not lithium; removing the precipitated second alkali metal salt and the precipitated third sulfide; and removing the polar solvent to isolate the second sulfide and/or the first alkali metal salt.

### BRIEF DESCRIPTION OF DRAWINGS

The present disclosure may be understood by reference to the following detailed description taken in conjunction with the drawings briefly described below.

FIG. 1 refers to x-ray diffractograms of the lithium sulfide (Li₂S) synthesized in Examples 1, 2, 3, 4, and Comparative Example 1.

FIG. 2 refers to a Thermogravimetric Analysis of the lithium sulfide (Li₂S) synthesized in Example 3, Example 4, and Comparative Example 1.

FIG. 3 refers to x-ray diffractograms of the lithium sulfide (Li₂S) synthesized in Examples 5, 6, and 7.

FIG. 4 refers to x-ray diffractograms of the lithium sulfide (Li₂S) synthesized in Examples 8, 9, and 10.

FIG. 5 refers to x-ray diffractograms of the lithium sulfide (Li₂S) synthesized in Examples 10, 11, 12, and 13.

FIG. 6 refers to x-ray diffractograms of the technical grade lithium chloride (LiCl) lithium sulfide (Li₂S) synthesized in Example 14.

FIG. 7 refers to x-ray diffractograms of the technical grade lithium sulfide (Li₂S) and the lithium sulfide (Li₂S) synthesized in Example 15.

FIG. 8 refers to an x-ray diffractogram of the solid state electrolyte produced in Example 16.

FIG. 9 refers to a Thermogravimetric Analysis of the lithium sulfide (Li₂S) synthesized in Example 5 and in Comparative Example 1.

FIG. 10 refers to a Fourier-Transform Infrared Spectroscopy (FTIR) spectrum of the lithium sulfide (Li₂S) synthesized in Example 5 and in Comparative Example 1.

FIG. 11 refers to x-ray diffractograms of lithium sulfide (Li₂S) synthesized in an Na₂S only synthesis.

FIG. 12 refers to x-ray diffractograms of lithium sulfide (Li₂S) synthesized in an Na₂S only synthesis with an extra 10% by weight LiCl added as reactant.

FIG. 13 refers to x-ray diffractograms of lithium sulfide (Li₂S) synthesized in an Na₂S only synthesis wherein a NaHS•XH₂O reactant was utilized and the final product was approximately half Li₂S and half LiCl.

### DETAILED DESCRIPTION OF ILLUSTRATED EMBODIMENTS

In the following description, specific details are provided to impart a thorough understanding of the various embodiments of the disclosure. Moreover, to avoid obscuring the technology, some well-known methods, processes, devices, and systems finding application in the various embodiments described herein are not disclosed in detail.

The current disclosure provides a low-cost synthesis of a sulfide by allowing an alkali metal hydrosulfide and an alkali metal salt to dissolve in an aliphatic alcohol and/or like solvents in which a “double ion exchange” occurs. The end result is the synthesis of is a metal hydrosulfide and one or more alkali metal by-products where one or more by-products may be filtered out either by the appropriate selection of solvent or by adding an anti-solvent such as but not limited to a non-polar hydrocarbon then filtering out the undesirable product(s). The solvent(s) are then removed, optionally leaving an alkali metal hydrosulfide, which upon heating decomposes into hydrogen sulfide and the desired sulfide as a high purity product. The general reaction is:
1. Metathesis reaction in Ethanol

NaHS_{(EtOH)}+LiCl_{(EtOH)}→LiHS_{(EtOH)}+NaCl_{(S)}
2. Filter to remove by-products

LiHS_{(EtOH)}+NaCl_{(S)}→LiHS_{(EtOH)}
3. Remove Ethanol, Heat to form the desired Alkali metal sulfide, and Remove any H₂S

2LiHS_{(EtOH)}→Li₂S_{(S)}+H₂S_{(g)}→Li₂S_{(S)}

In another embodiment, the metathesis reaction may be summarized by the following equation:
1. Metathesis Reaction in Ethanol

Na₂S+2LiCl→Li₂S+2NaCl

The above reaction may be carried out by dissolving the starting material in ethanol which may provide a double ion exchange (metathesis) reaction forming Li₂S and NaCl. The NaCl may have very low solubility in the ethanol as compared to the Li₂S, such that the NaCl may be removed by filtering, leaving Li₂S dissolved in ethanol, which may be removed via a drying process. In the reactions described herein, Li₂CO₃, Li₂O and Li₃OCl (e.g., impurity composite materials) may be produced individually or collectively in amounts ≤10%, ≤7%, ≤5%, ≤4%, ≤3%, ≤2%, ≤1%, or ≤0.5% by weight, and may be removed by heating while exposing the composite materials to a sulfur source.

In yet another aspect, NaHS may optionally be used to produce LiHS, as summarized by the following equation:

Na₂S+2NaHS+4LiCl→Li₂S+2LiHS+4NaCl→2Li₂S+H₂S+4NaCl

As shown above, the LiHS may be heated and/or reacted to decompose into to Li₂S and H₂S at a temperature of about 150° C. or greater (e.g., from about 150° C. to about 300° C.). By introducing a sulfur source at an elevated temperature, composite materials comprising Li₂CO₃, Li₂O and/or Li₃OCl maybe be removed or eliminated to individually or collectively in amounts ≤10%, ≤7%, ≤5%, ≤4%, ≤3%, ≤2%, ≤1%, or ≤0.5% by weight.

In a further embodiment, NaHS may optionally be reacted in a hydrated form and/or along with water, as summarized by the following equation:

Na₂S+2NaHS•XH₂O+4LiCl→Li₂S+2LiHS+4NaCl→3Li₂S+H₂S+4NaCl

and/or

Na₂S+2NaHS+XH₂O+4LiCl→Li₂S+2LiHS+4NaCl→3Li₂S+H₂S+4NaCl

As shown above, the NaHS may be used in “wet” form, such as including X moles of hydrate or being in contact with X moles of H₂O. In the above equation, NaHS•XH₂O (or a similar hydrate) may comprise from about 20% to about 75% water by weight, from about 15% to about 70% water by weight, from about 10% to about 65% water by weight, from about 5% to about 65% water by weight, from about 0% to about 55% water by weight, from about 20% to about 50% water by weight, from about 20% to about 45% water by weight, from about 20% to about 40% water by weight, from about 20% to about 35% water by weight, from about 20% to about 30% water by weight, from about 20% to about 25% water by weight, or from about 25% to about 30% water by weight. Experimentally, however, it has been discovered that combining the “wet form” of NaHS with Na₂S with LiCl (i.e., Na₂S+2NaHS•XH₂O+4LiCl) may yield lithium sulfide, lithium chloride and substantially no lithium oxides (i.e., 2Li₂S+2LiCl+No Li Oxides). Thus, the experimental results suggest that the following reactions may be taking place.

Na₂S+2NaHS•XH₂O+4LiCl→Li₂S+2LiHS+4NaCl→2Li₂S+2LiCl+No Li Oxides

and/or

Na₂S+2NaHS+XH₂O+4LiCl→Li₂S+2LiHS+4NaCl→2Li₂S+2LiCl+No Li Oxides

and/or

Na₂S+2NaHS•XH₂O+4LiCl→2Li₂S+2LiCl+No Li Oxides

In some embodiments, among the starting reagents, only NaHS•XH₂O is in “wet” or hydrated form. As such, in one aspect, Na₂S and LiCl are dried and/or in anhydrous form and NaHS•XH₂O is in “wet” or hydrated form prior to reaction, and the final products Li₂S and LiCl are over 94% pure, over 95% pure, over 96% pure, over 97% pure, over 98% pure, over 98.5% pure, over 99% pure, over 99.5% pure and substantially free from lithium oxides (i.e., ≤6.0%, ≤5.0%, ≤4.0%, ≤3.0%, ≤2.0%, ≤1.5%, ≤1.0%, or ≤0.5% lithium oxides). Other potential benefits to the reactions described herein are that the reaction(s) may occur wherein (1) the final product LiCl may be recycled into the starting materials to increase purity of the LiCl; (2) “dirty” or technical grade LiCl (e.g., LiCl with purity of 97% or less, 95% or less, 90% or less, 85% or less, 80% or less, 75% or less, 70% or less, 65% or less, 60% or less, 55% or less, or 50% or less) may be “cleaned” or purified by incorporating the low purity “dirty” LiCl into starting reaction and yielding a LiCl with at least about 2%, at least about 3%, at least about 4%, at least about 5%, at least about 10%, at least about 15%, at least about 20%, at least about 25%, at least about 30%, at least about 35%, at least about 40%, at least about 45%, or at least about 50% greater purity than the LiCl starting material; (3) the final product Li₂S may be recycled into the starting materials to increase purity of the Li₂S even further, (4) “dirty” Li₂S (e.g., Li₂S with purity of about 97% or less, 95% or less, 90% or less, 85% or less, 80% or less, 75% or less, 70% or less, 65% or less, 60% or less, 55% or less, or 50% or less) may be “cleaned” or purified by incorporating the low purity “dirty” Li₂S into starting reaction and yielding a Li₂S with at least about 2%, at least about 3%, at least about 4%, at least about 5%, at least about 10%, at least about 15%, at least about 20%, at least about 25%, at least about 30%, at least about 35%, at least about 40%, at least about 45%, or at least about 50% greater purity than the Li₂S starting material; and/or (5) impurities convert into non-soluble sulfides. Generally, impurities may be non-soluble oxides and therefore may prevent the formation of other oxide impurities. In one aspect, 95% pure may be “cleaned” or purified by incorporating the low purity “dirty” LiCl into starting reaction and yielding a LiCl with ≥99% purity. Yet another surprising aspect of the reactions described herein is that they may be used to make a novel and highly pure LiNaS material (i.e., at least 55% pure, at least 60% pure, at least 65% at least 70% pure, pure, at least 75% pure, at least 80% pure, at least 85% pure, at least 90% pure, at least 91% pure, at least 92% pure, at least 93% pure, at least 94% pure, at least 95% pure, at least 96% pure, at least 97% pure, at least 98% pure, at least 99% pure, at least 99.5% pure individually and/or collectively). This reaction may be summarized by the below:

Na₂S+2NaHS•XH₂O+4LiCl→4LiNaS

The “dirty” or technical grade LiCl referred to herein may contain impurities that include salts, such as sodium salts, potassium salts, magnesium salts, silicon salts, iron salts, nickel salts, copper salts, etc. In some aspects, the salts may be chloride salts, such as sodium chloride (NaCl), potassium chloride (KCl), calcium chloride (CaCl₂), magnesium chloride (MgCl₂), silicon chloride (SiCl₂), iron chloride (FeCl₂), nickel chloride (NiCl₂), and copper chloride (CuCl₂). All of these salts (with the exception of sodium chloride and potassium chloride) are highly soluble in alcohols, and thus cannot be removed by simple filtration with an alcohol solvent. By adding Na₂S or NaHS and dissolving in ethanol, the unwanted chloride salts may convert to metal sulfides which are insoluble in alcohols.

The “dirty” or technical grade Li₂S may contain impurities that include lithium hydroxide (LiOH), lithium sulfate (Li₂SO₄), carbon, lithium carbonate (Li₂CO₃), and lithium oxide (Li₂O).

When using Na₂S in wet form, the water may react with the lithium in the LiCl forming different Li—O containing species (Li₂O, Li₂CO₃, etc.). Surprisingly, however, when the NaHS comprises water in a hydrate form, including but not limited to the percentages water by weight described above, the hydrate does not react with the lithium or form any unwanted contaminates or impurities (Li₂O, Li₂CO₃, Li₃OCl, etc.). The product materials may be heated and or dried at about 100° C. to about 150° C., at about 150° C. to about 200° C., at about 200° C. to about 250° C., at about 250° C. to about 300° C., at about 300° C. to about 350° C., at about 350° C. to about 400° C., at about 400° C. to about 450° C.

Na₂S+2NaHS•XH₂O+4LiCl→Li₂S+2LiHS+4NaCl→3Li₂S+H₂S+4NaCl+LiCl

and/or

Na₂S+2NaHS+XH₂O+4LiCl→Li₂S+2LiHS+4NaCl→3Li₂S+H₂S+4NaCl+LiCl

The reaction may also be used to produce Li₂S and LiCl as final products without any substantial Li-based impurities (i.e., rather than the expected Li₃OCl impurity). Li₂S and LiCl produced by this reaction may be substantially free of impurities (i.e., at least 75% pure, at least 80% pure, at least 85% pure, at least 90% pure, at least 91% pure, at least 92% pure, at least 93% pure, at least 94% pure, at least 95% pure, at least 96% pure, at least 97% pure, at least 98% pure, at least 99% pure, at least 99.5% pure individually and/or collectively). In one aspect, Li₂S and LiCl produced by this reaction may be substantially free of impurities selected from the group consisting of Li₂O, Li₂CO₃, Li₃OCl, LiOH, Li₂SO₄, Li₂CO₃, and combinations thereof. Li₂S and LiCl produced by this reaction may be at least 75% free from impurities, at least 80% free from impurities, at least 85% free from impurities, at least 90% free from impurities, at least 95% free from impurities, at least 96% free from impurities, at least 97% free from impurities, at least 98% free from impurities, at least 99% free from impurities, or at least 99.5% free from impurities, wherein the impurities may be selected from the group consisting of Li₂O, Li₂CO₃, Li₃OCl, LiOH, Li₂SO₄, Li₂CO₃, and combinations thereof. This high degree of purity is unexpected and surprising.

The reaction may also be used to produce Li₂S and LiCl as final products without any substantial impurities (i.e., rather than the expected Li₃OCl impurity). Li₂S and LiCl produced by this reaction may be substantially free of impurities (i.e., at least 75% pure, at least 80% pure, at least 85% pure, at least 90% pure, at least 91% pure, at least 92% pure, at least 93% pure, at least 94% pure, at least 95% pure, at least 96% pure, at least 97% pure, at least 98% pure, at least 99% pure, at least 99.5% pure individually and/or collectively). In one aspect, Li₂S and LiCl produced by this reaction may be substantially free of impurities selected from the group consisting of NaCl, KCl, CaCl, MgCl, SiCl₂, FeCl₂, NiCl₂, CuCl₂, CaS, MgS, FeS, NiS, and combinations thereof. Li₂S and LiCl produced by this reaction may be at least 75% free from impurities, at least 80% free from impurities, at least 85% free from impurities, at least 90% free from impurities, at least 95% free from impurities, at least 96% free from impurities, at least 97% free from impurities, at least 98% free from impurities, at least 99% free from impurities, or at least 99.5% free from impurities, wherein the impurities may be selected from the group consisting of NaCl, KCl, CaCl, MgCl, SiCl₂, FeCl₂, NiCl₂, CuCl₂, CaS, MgS, FeS, NiS, and combinations thereof. This high degree of purity is unexpected and surprising.

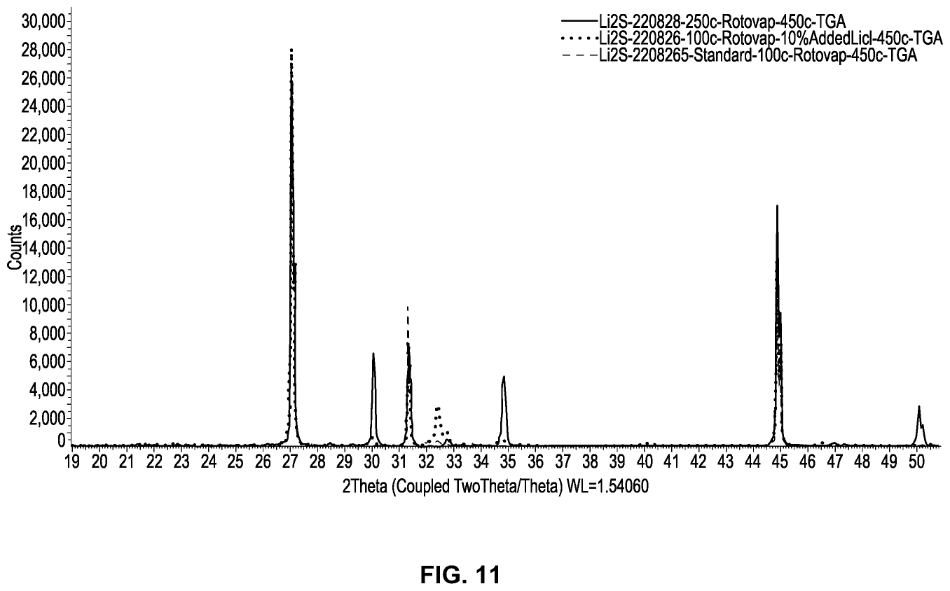

In one embodiment, in the standard Na₂S only synthesis, the final product may yield approximately 94.0% pure Li₂S with the major impurity being NaCl and the minor impurity being Li₃OCl where the decomposition products of the Li₃OCl are Li₂O and LiCl. The blue peaks in the X-Ray Diffraction Spectra shown in FIG. 11 represent the 94.0% pure Li₂S and ≤6.0% impurity (e.g., Li₃OCl).

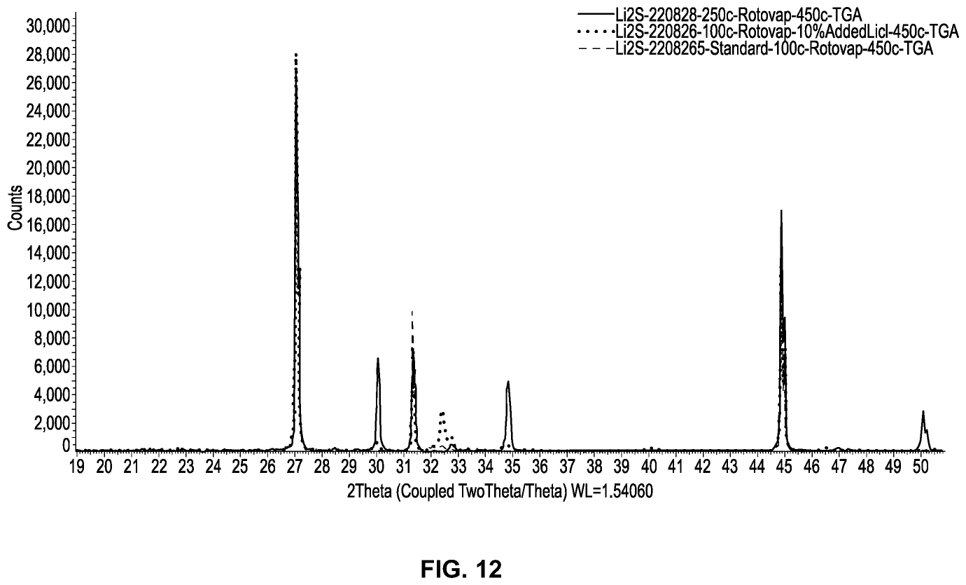

In another embodiment, in the standard Na₂S only synthesis with an extra 10% by weight LiCl added as reactant, the final product may yield approximately 80.8% pure Li₂S with the major impurity being Li₃OCl and a minor impurity being LiCl. The red peaks in the X-Ray Diffraction Spectra shown in FIG. 12 represent the 80.8% pure Li₂S. In one aspect the Na₂S-only synthesis (e.g., no water or hydrate) with the additional 10% LiCl as a reactant, there is a large increase in the amount of Li₃OCl generated.

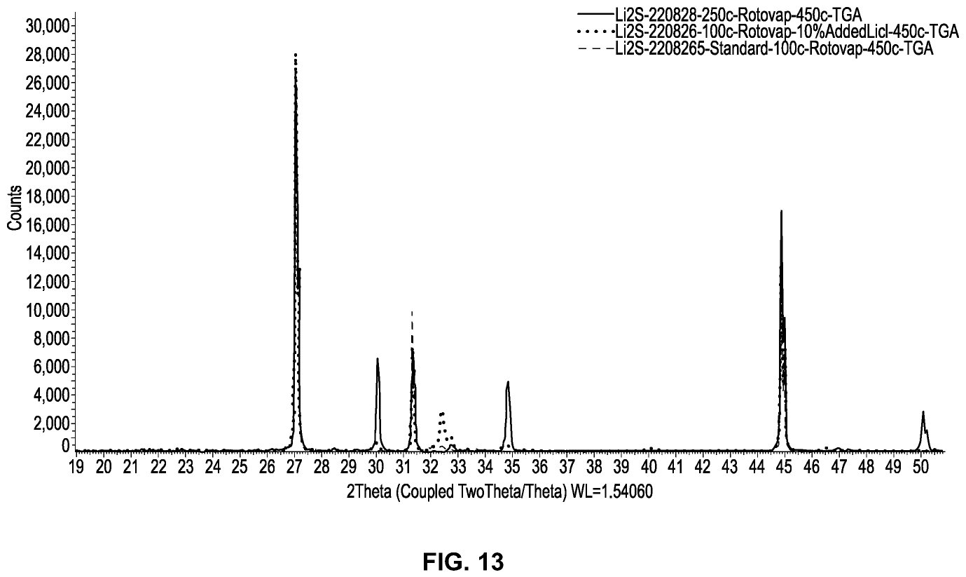

In yet another embodiment, the NaHS•XH2O reactant was utilized and the final product was approximately half Li₂S and half LiCl, at greater than 95% purity each. The black peaks in the X-Ray Diffraction Spectra shown in FIG. 13 represent the 51.5% Li₂S and 47.5% LiCl reaction products. The final product is 51.5% Li₂S, 47.5% LiCl, and 1% unidentified. However, each of these reaction products is generated at ≥95% purity.

To reiterate one aspect of the unexpected results, however, using the NaHS•XH2O reaction, it may be possible to produce about 45% to about 55% LiCl and about 45% to about 55% Li₂S, simultaneously (i.e., a composite reaction product), without generating any Li₃OCl (i.e., less than 1.0%, less than 0.5%, less than 0.3%, less than 0.1%, less than 0.01% by weight). Stated differently, Na₂S+2NaHS•XH₂O+4LiCl may be combined to produce Li₂S and LiCl in a combined yield of at least 90%, of at least 91%, of at least 92%, of at least 93%, of at least 94%, of at least 95%, of at least 96%, of at least 97%, of at least 98%, of at least 99%, of at least 99.5%, of at least 99.7%, or of at least 99.9%. The conditions of the reaction may be adjusted to yield about 0% to about 5%, about 5% to about 15%, about 15% to about 25%, about 25% to about 35%, about 35% to about 45%, about 45% to about 55%, about 55% to about 65%, about 65% to about 75%, about 75% to about 85%, about 85% to about 95%, about 95% to about 99% LiCl and about 0% to about 5%, about 5% to about 15%, about 15% to about 25%, about 25% to about 35%, about 35% to about 45%, about 45% to about 55%, about 55% to about 65%, about 65% to about 75%, about 75% to about 85%, about 85% to about 95%, about 95% to about 99% Li₂S. Likewise, Na₂S+2NaHS+XH₂O+4LiCl may be combined to produce Li₂S and LiCl in a combined yield of at least 90%, of at least 91%, of at least 92%, of at least 93%, of at least 94%, of at least 95%, of at least 96%, of at least 97%, of at least 98%, of at least 99%, of at least 99.5%, of at least 99.7%, or of at least 99.9%.

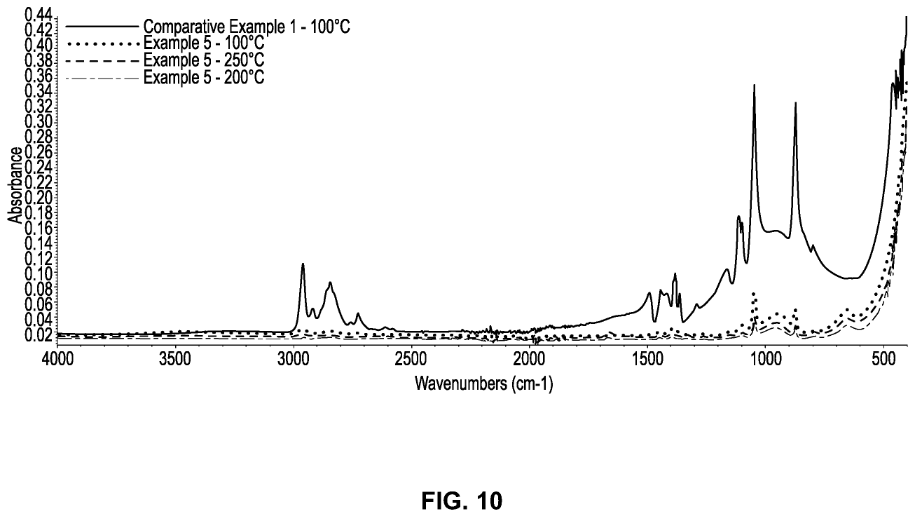

In the FT-IR spectra shown in FIG. 10, the red line is a standard “Na₂S only” synthesis where the material may be dried to 100° C. The others lines in the spectra are made using 33% NaHS•XH2O and dried to 100° C. (green), 200° C. (blue), and 250° C. (purple). For the three non-red spectra, there may be a large decrease in the peaks (2750-3000) associated with residual solvents (ethanol) and the peaks (850-1500) associated with ethoxides. This may be evidence for the production of H₂S by the NaHS decomposing into Na₂S and H₂S. This may also be evidence of forming of LiHS, which is then decomposing into Li₂S or H₂S.

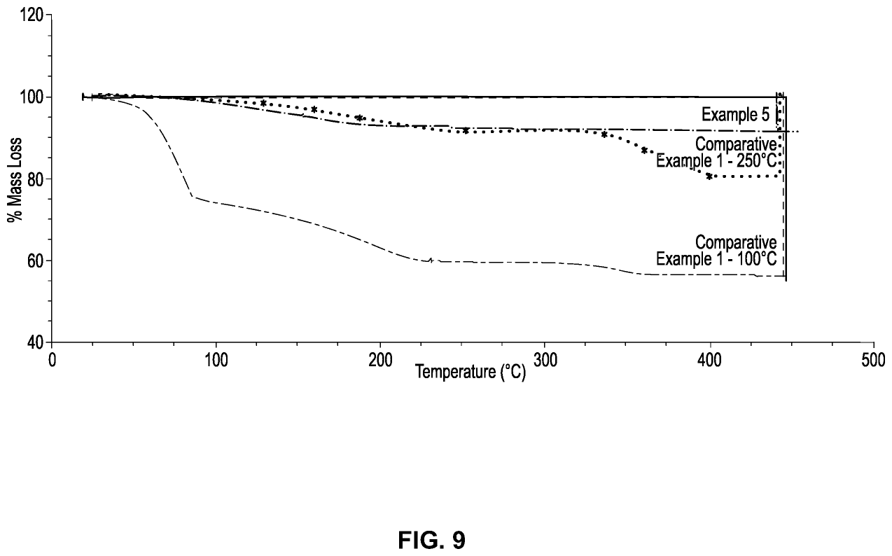

In the thermogravimetric analysis shown in FIG. 9, the line labeled Example 5 indicates a 33% NaHS•XH₂O reaction with products dried to 100° C. to about 200° C., such that ≥97%, ≥98%, ≥99%, or ≥99.5%, of all solvents are removed from the Li₂S and LiCl products. In such an embodiment, the reactions described herein may be used to produce dry nano sided Li₂S particles at temperatures of 100° C. or lower, 150° C. or lower, 200° C. or lower, 250° C. or lower, 300° C. or lower, 350° C. or lower, 400° C. or lower, or 450° C. or lower. In yet another aspect, the average crystal size of the Li₂S reaction product may be about 0.50 to 1.50 microns in diameter, about 0.75 to 1.25 microns in diameter, about 1 to about 3 microns in diameter, about 1 to about 7 microns in diameter, about 1 to about 10 microns in diameter, about 0.5 to about 3 microns in diameter, about 0.5 to about 5 microns in diameter, about 0.5 to about 7 microns in diameter, or about 0.5 to about 10 microns in diameter, or about 0.5 to about 25 microns in diameter.

In another embodiment, it may be possible to produce a composite of Li₂S and a lithium halide (LiF, LiCl, LiBr, LiI) using the NaHS•XH₂O reaction. This may be achieved by beginning the reaction with an excess of one or more lithium halides.

In another embodiment, the current disclosure provides a low-cost synthesis of a sulfide (and/or a purified alkali metal salt) by allowing a first alkali metal hydrosulfide, a first sulfide, and a first alkali metal salt to dissolve in an aliphatic alcohol and/or like solvents in which a “double ion exchange” occurs. The end result is the synthesis of a second alkali metal hydrosulfide, a second sulfide, and one or more of a purified first alkali metal salt or second alkali metal salt by-products where the one or more by-products may be precipitated and removed, either by the appropriate selection of solvent or by adding an anti-solvent such as but not limited to a non-polar hydrocarbon, then filtering out the undesirable product(s). The solvent(s) may then be removed, leaving a second alkali metal hydrosulfide and a second sulfide, where upon heating, the second alkali metal hydrosulfide decomposes into hydrogen sulfide and the desired second sulfide. The released hydrogen sulfide may then convert any metal oxide species into the desired second sulfide. The final produce is second sulfide of high purity and/or an alkali metal salt of high purity. One general reaction is:

1. Metathesis reaction in Ethanol

NaHS_{(EtOH)}+Na₂S_{(EtOH)}+LiCl_{(EtOH)}→LiHS_{(EtOH)}+Li₂S_{(EtOH)}+NaCl_{(S)}

2. Filter to remove by-product

LiHS_{(EtOH)}+Li₂S_{(EtOH)}+NaCl_{(S)}→LiHS_{(EtOH)}+Li₂S_{(EtOH)}

3. Remove Ethanol, Heat, and Remove any H₂S

2LiHS_{(EtOH)}+Li₂S_{(EtOH)}→2Li₂S_{(S)}+H₂S_{(g)}→2Li₂S_{(S)}

The present disclosure illustrates a process for producing lithium sulfide through a double ion exchange reaction that takes place in a polar organic solvent, where the reactants are one or more of a lithium metal salt, one or more of an alkali metal hydrosulfide, and one or more alkali metal sulfide compound thereby producing lithium sulfide, lithium hydrosulfide, and one or more of an alkali metal salt. The particular lithium metal salt, alkali metal hydrosulfide, alkali metal sulfide and polar organic solvent should be selected such that lithium metal salt, the alkali metal hydrosulfide and the alkali metal sulfide have a high solubility in the polar solvent, and the newly formed alkali metal salt produced from the ion exchange reaction has a low solubility in the polar organic solvent. The newly formed alkali metal salt, having low solubility in the polar organic solvent, precipitates and is removed from the solution containing lithium sulfide and lithium hydrosulfide. The polar organic solvent is removed such that a composite of lithium metal hydrosulfide and lithium sulfide remain. This composite is then heated to produce an alkali metal sulfide through the decomposition of the lithium hydrosulfide to lithium sulfide, releasing hydrogen sulfide gas which helps to reduce any oxide species thereby yielding a highly pure lithium sulfide product.

In the process of the current disclosure the first alkali metal salts and second alkali metal salts may be one or more of, but are not limited to, LiF, LiCl, LiBr, and LiI. The first alkali hydrosulfide may be one or more of, but not limited to LiHS, NaHS, or KHS. The first alkali hydrosulfide, such as LiHS, NaHS, or KHS, may be substantially anhydrous or dried. In an alternative embodiment, the first alkali hydrosulfide, such as LiHS, NaHS, or KHS, may be in hydrate form. The first alkali hydrosulfide, such as LiHS, NaHS, or KHS, may comprise a water content from about 0% to about 30%, about 5% to about 25%, about 10% to about 20%, about 15% to about 30%, about 20% to about 30%, about 20% to about 25%, or about 25% to about 30%. The first alkali hydrosulfide, such as LiHS, NaHS, and/or KHS in hydrate form, may comprise a water content from about 20% to about 75%, from about 25% to about 80% or from about 30% to about 85%. The first alkali metal salts and the first alkali metal hydrosulfide compounds may be in a form that is one or more of, but not limited to, powders, pellets, flakes, or bricks.

In some embodiments, the present disclosure illustrates a process for producing a Li₂S material where the hydrosulfide precursor may be partially substituted with a sulfide precursor. In this process, the lithium sulfide is produced though a double ion exchange reaction that takes place in a polar organic solvent where the reactants are one or more of a lithium metal salt, one or more of an alkali metal hydrosulfide compound, and one or more of an alkali metal sulfide. From this stage in the process, lithium sulfide, lithium hydrosulfide and an alkali metal salt by-product are produced. The combination of lithium metal salt, alkali metal hydrosulfide, alkali metal sulfide, and polar organic solvent should be selected such that lithium metal salt, the alkali metal hydrosulfide, and the alkali metal sulfide have a high solubility in the polar solvent, and the newly formed alkali metal salt produced from the ion exchange reaction has a low solubility in the polar organic solvent. The newly formed alkali metal salt, having low solubility in the polar organic solvent, precipitates and is removed from the mixture containing lithium hydrosulfide and lithium sulfide. The polar organic solvent is removed from the mixture of lithium hydrosulfide and lithium sulfide. The mixture of lithium hydrosulfide and lithium sulfide is heated to the point where the lithium hydrosulfide decomposes into lithium sulfide and hydrogen sulfide. The newly produced hydrogen sulfide aids in the reduction of any potential oxide species that formed leaving lithium sulfide a high purity.

In accordance with an embodiment of the current disclosure, the sulfide precursor compounds may include, but are not limited to Li₂S, Na₂S, K₂S, and (NH₄)₂S. The lithium containing salts may be one or more of, but are not limited to, LiF, LiCl, LiBr, and LiI. The first alkali metal hydrosulfide may be one or more of, but not limited to LiHS, NaHS, or KHS, or hydrates thereof. The lithium containing salts and the hydrosulfide may be in a form that is one or more of, but not limited to, powders, pellets, flakes, or bricks. In some embodiments, any hydrosulfide of a monovalent cation or sulfide of a monovalent cation that is soluble in the polar organic solvent may be used as long as the corresponding alkali metal salt by-product has a solubility lower than that of the lithium sulfide and lithium hydrosulfide. The low solubility alkali metal salt may be referred to as a low solubility by-product and may be one or more of but not limited to an alkali metal halide comprising Sodium or Potassium such as NaCl, NaBr, NaI, KCl, KBr, KI. In another embodiment, the low solubility alkali metal salt may comprise Rubidium and Cesium and may be one or more of a RbCl, RbBr, RbI, CsCl, CsBr, and CsI.

To facilitate the double ion exchange reaction between the starting materials, one or more the alkali metal salts, one or more sulfide compounds, and one or more of the hydrosulfide compounds may be individually or jointly added to one or more of the polar organic solvents. In some embodiments, one or more of the alkali metal salts, one or more sulfide compounds, and one or more of the hydrosulfide compounds may be combined before their addition to the one or more of the polar organic solvents. The combining of these materials may result from blending, mixing, grinding, or milling of the starting materials. In another embodiment, one or more of the alkali metal salts, one or more sulfide compounds, and one or more of the hydrosulfide compounds may be dissolved into solution independently before the other starting materials are joined to form a combined solution. The polar organic solvents may include but are not limited to one or more alcohols or diols. In some embodiments, the alcohols may be one or more of a primary, secondary or tertiary alcohol. In another embodiment, the alcohol may be one or more of an ethanol, 1-propanol, and 1-butanol. In a further embodiment, the alcohol may be one or more of an isopropanol, isobutanol and isopentanol. In some embodiments, the solvents may include diols such as but not limited to ethylene glycol, propylene glycol, 1,4-butanediol, 1,5-pentanediol, and 1,6-hexanediol. The solvent is not particularly limited as long as the solubility of the alkali metal hydrosulfide and alkali metal sulfide remains higher than that of the solubility of the alkali metal salt by-product.

In some embodiments, if the alkali metal hydrosulfide and alkali metal salt by-product produced from this reaction has substantially similar solubility in the polar organic solvent, purifying the desired lithium sulfide product may be complicated. In another embodiment, if the temperature used during dissolution is too high, undesirable side reactions between the precursors and the solvent may occur potentially lowing the purity or yield of the final lithium sulfide product. In a further embodiment, if the temperature used during dissolution is too low, the solubility of the starting materials may be too low for the reaction to proceed.

When operating at room temperature, 25° C., one or more of the by-products produced from this reaction may naturally precipitate from the solution to form a mixture containing one or more of the high solubility lithium sulfide and lithium hydrosulfide in the supernatant, and a precipitate of the low solubility alkali metal salt by-product. By introducing cooling, the rate of precipitation may be altered. Additionally, cooling may also generate additional precipitation of one or more of the low solubility alkali metal by-products.

To further manipulate purity levels, the ratios and amounts of the various starting materials and polar organic solvents are not specifically limited and may be altered as long as the alteration allows for the synthesis of lithium sulfide to proceed. In some embodiments, the volume or weight ratio of solvents to individual precursor amounts may be adjusted to prevent side reactions. In some embodiments, additional lithium salts or other alkali metal salts may be added if it is desirable to synthesize a composite lithium sulfide and alkali metal salt. In another embodiment, one or more of a polar solvent in an amount less than what is required for a full dissolution of one or more of the lithium salts, alkali metal sulfides, or alkali metal hydrosulfides may be used. In such an embodiment, grinding or milling a mixture of at least one or more lithium salt and alkali metal hydrosulfide in one or more polar organic solvents may produce the desired lithium sulfide while using less solvents overall. In a further embodiment, the noted compounds may be mixed with non-polar solvents such as but not limited to heptane, octane, benzene, toluene and xylenes. In another embodiment, additional materials, such as co-solvents or flocculant, may also be added to aid in the removal of the precipitated alkali metal salt by-product.

Stirring or other mixing may be used to homogenize the solution and the mixing time is not specifically limited as long as it allows for the appropriate homogenization and reaction of precursors to generate the lithium hydrosulfide and/or lithium sulfide, and one or more alkali metal salt by-products. Mixing temperature is not specifically limited as long as it allows for appropriate mixing and is not so high as to drive the formation of undesirable materials or so low as to suppress the solubility of one or more of the alkali metal sulfide or hydrosulfide to the point of halting the reaction. In some embodiments, mixing may be performed at temperatures ranging from −50° C. to 120° C. using, for example, magnetic stirrers or a shaft mixer. In another embodiment, the temperature range may be from −40° C. to 100° C. In yet another embodiment, the temperature range may be from −30° C. to 80° C. In yet a further embodiment, the temperature range may be from −20° C. to 60° C. Homogenization may be carried out in a batch process or as a continuous process aided by rapid reaction kinetics. In some embodiments, one or more of an anti-solvent such as heptane, octane, benzene, toluene, xylenes, or another aprotic hydrocarbons may be added to the solution to aid in the precipitation of one or more alkali metal by-products. In some embodiments, the anti-solvent is substantially miscible in the range of 7:1 v/v Non-polar/polar to 1:2 v/v Non-polar/polar. In another embodiment, at least 3:1 v/v Non-polar/polar is used without affecting the solubility of one or more of the alkali metal sulfide or hydrosulfides. In a further embodiment, additional amounts of an ionic compound such as a lithium containing salt to the polar organic solvent solution may further lower the solubility of one or more by-products. The total amount the additional lithium containing salt material may be 150% to 85% of stoichiometric in order to improve product purity and/or include some amount of the lithium containing salts with one or more of the final lithium metal sulfide or hydrosulfide. For example, a material product that combines well-mixed Li₂S and LiCl is useful as a precursor for producing sulfide solid electrolytes comprising Li⁺, S⁻², Cl⁻.

Removal or separation of one or more of the by-products may result from one or more separation methods such as centrifuging, filtering, or gravity settling. These separation methods may be used separately or in combination to separate the alkali metal salt by-product from the mixture to isolate the supernatant containing one or more of a high solubility alkali metal hydrosulfide and lithium sulfide. In some embodiments, filtering may be performed after the initial double ion exchange reaction followed by the addition of a quantity of an antisolvent to the solution to precipitate a further amount of by product.

Separation of the solvent from the supernatant to isolate the lithium hydrosulfide and/or the lithium sulfide may be accomplished by evaporating the solvent. It may be noted that the mixture may appear dry after the bulk solvent has been removed but may contain solvent that makes up 75% the total weight. It may be beneficial to utilize solvents with low heat of evaporation that use less energy to remove. Furthermore, solvents may be recycled and reused.

After isolation of the targeted lithium hydrosulfide and/or the lithium sulfide, the remaining bound solvent may be removed by heating in an inert atmosphere such as argon or nitrogen or under vacuum for a predetermined period of time and temperature prior to storage or use. The temperature range is not limited and for example may be in the range of 25° C. to 900° C. In some embodiments, the temperature range may be 200° C. to 700° C. In another embodiment, the temperature range may be 300° C. to 500° C.

This heating process may sinter the sulfide including Li₂S. As synthesized, the Li₂S may have a particle size less of than 1 micron. After heating the Li₂S at a temperature at or above 300° C., the average particle size of the Li₂S may be above 1 micron.

While the lithium hydrosulfide or a composite containing lithium hydrosulfide is heated, the lithium hydrosulfide may decompose into lithium sulfide releasing hydrogen sulfide gas. This hydrogen sulfide gas may react with oxygen containing species converting them into sulfides or hydrosulfides.

Due to the decomposition of lithium hydrosulfide into hydrogen sulfide gas and lithium sulfide, the materials used to facilitate the reaction such as solvents and precursors used may not need to be anhydrous. However, lowing the total amount of water that enters the system may limit the production of undesirable oxide species. This is due to that fact that lithium sulfide is very soluble in water and hydrolyses to lithium hydroxide releasing hydrogen sulfide gas. Lithium hydroxide has a very low solubility in alcohols and other polar solvents. Thus, if lithium hydroxide is formed during the dissolution of the precursors, it may be removed from the system along with the alkali metal salt by-products when filtering or centrifuging occurs. This will lower the yield of the desired lithium sulfide. This problem may be avoided by lowering the temperature of the system slowing or preventing the formation of lithium hydroxide. In some embodiments, the total amount of water that enters the system may be less than 19 weight percent with respect to the amount of Lithium hydrosulfide that is used in the reaction. For example, one or more of the polar organic solvents may have a water content in the range of 0% to 5% by weight. In some embodiments, the water content is less than 1% by weight. In another embodiment, the water content is less than 0.1% by weight. In a further embodiment, the water content is less than 200 ppm. For one or more of lithium containing salts, alkali metal hydrosulfide, and alkali metal sulfide, water content in the range of 0% to 10% by weight. In some embodiments, the water content is less than 5% by weight. In another embodiment, the water content is less than 1% by weight. In a further embodiment, the water content is less than 0.1% ppm. In yet another embodiment, the water content is less than 500 ppm.

To further prevent the formation of undesirable oxide species, sulfur in the form of H₂S or elemental sulfur may be introduced at various stages of the synthesis process. Sulfur may be partially or fully dissolved into the polar and or non-polar solvents prior to the addition of the lithium containing salt, sulfide precursor, or the hydrosulfide material. The sulfur source may also be added to the solution containing the lithium containing salt, to the solution containing the hydrosulfide material or both solutions. When elemental sulfur is used and is added to a solution containing a sulfide material, a polysulfide such as Na₂Sₓ, where X is greater than 1 but less than or equal to 10, may form. The polysulfide may have a greater solubility than the non-polysulfide version of the material (Na₂S₅ vs Na₂S) and may be less prone to hydrolyzation. With an increased solubility, the total amount of the solvent used may be lower than its non-polysulfide counterpart. These polysulfides may also be formed by bubbling hydrogen sulfide gas through a solution of alkali metal sulfide. However, when elemental sulfur is added to a solution containing a hydrosulfide material, the hydrosulfide material may decompose into hydrogen sulfide and its corresponding alkali metal sulfide material.

The introduction of a sulfur source may also occur any point during the drying or high-temperature treatment of the lithium hydrosulfide or lithium hydrosulfide-lithium sulfide composite. When evaporating the solvents at elevated temperature under vacuum, elemental sulfur may be introduced by means of mixing, blending, or grinding. Due to the high volatility of elemental sulfur under high temperature, low pressure conditions, the elemental sulfur may need to be added in far excess of that which is needed to reduce any undesirable oxides species. In some embodiments, the amount of sulfur added may be 100% or less of the weight of the lithium hydrosulfide or lithium hydrosulfide and lithium sulfide mixture. In another embodiment, the amount of sulfur added may be 50% or less of the weight of the lithium hydrosulfide or lithium hydrosulfide and lithium sulfide mixture. In a further embodiment, the amount of sulfur added may be 25% or less of the weight of the lithium hydrosulfide or lithium hydrosulfide and lithium sulfide mixture. In yet another embodiment, the amount of sulfur added may be 10% or less of the weight of the lithium hydrosulfide or lithium hydrosulfide and lithium sulfide mixture. In a further embodiment, the amount of sulfur added may be 5% or less of the weight of the lithium hydrosulfide or lithium hydrosulfide and lithium sulfide mixture. The composite comprising sulfur and the lithium hydrosulfide may then be heated to the desired temperatures where the sulfur melts or sublimates, aiding in the removal of solvents and converting any oxygen-containing compounds to metal sulfides.

For purpose of this disclosure, the term “substantially” means at a state that is near 100% (including 100%) of a certain parameter. By way of example, near 100% may span a range from around 80% to 100%, from around 90% to 100%, or from around 95% to 100%.

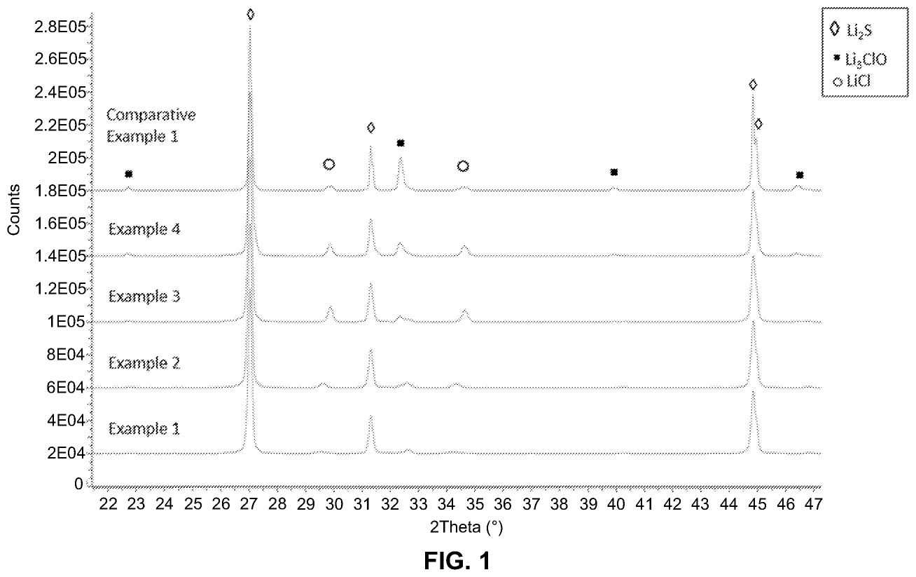

FIG. 1 depicts the X-Ray Diffraction of the Li₂S material synthesized by Example 1-4 and Counter Example. From this figure, it may be shown that Example 1-4 all have a purity of >80% Li₂S where two of these Examples, Example 1 and 2, have purities >90% Li₂S, and Example 1 has a purity of >95% Li₂S. The amount of LiCl present in the Li₂S mixture may be lowered by manipulating the molar ratios of Lithium containing species to Sodium containing species. The amount of NaCl present in the composite may be lowered by altering the process used to remove the NaCl such as further incorporating one or more techniques such as centrifuges, filters, cooling of the mixture, and the addition of flocculants. The amount of Oxyhalide species such as Li₃ClO may be further reduced through increasing the ratio of NaHS to Na₂S used in the synthesis of Li₂S. The amount of Oxyhalide species such as Li₃ClO or other Oxygen containing species such as Li₂CO₃, Li₂SO₄, Li₂O, or LiOH may be reduced or eliminating by incorporating a sulfur source in the form of H₂S and Elemental Sulfur during one or more steps of the synthesis process, drying, or heat treatment of the resulting Li₂S mixture. With these changes, it is possible to produce Li₂S at a purity of 99% or above.

TABLE 1

| | Ratio of | Li₂S | Li₃OCl | Li₂CO₃ | LiCl | NaCl |
|---|---|---|---|---|---|---|
| | Na₂S:NaHS | (wt %) | (wt %) | (wt %) | (wt %) | (wt %) |
| Example 1 | 2:2 | 95.2 | 2.5 | 0.8 | 1.1 | 0.4 |
| Example 2 | 3:2 | 93.9 | 2.7 | 0 | 3.1 | 0.3 |
| Example 3 | 4:2 | 87.5 | 3.4 | 0 | 8.9 | 0.2 |
| Example 4 | 9:2 | 84.7 | 8.3 | 0 | 6.8 | 0.2 |
| Comparative | 10:0 | 78.8 | 18.8 | 0 | 2.1 | 0.2 |
| Example 1 | | | | | | |

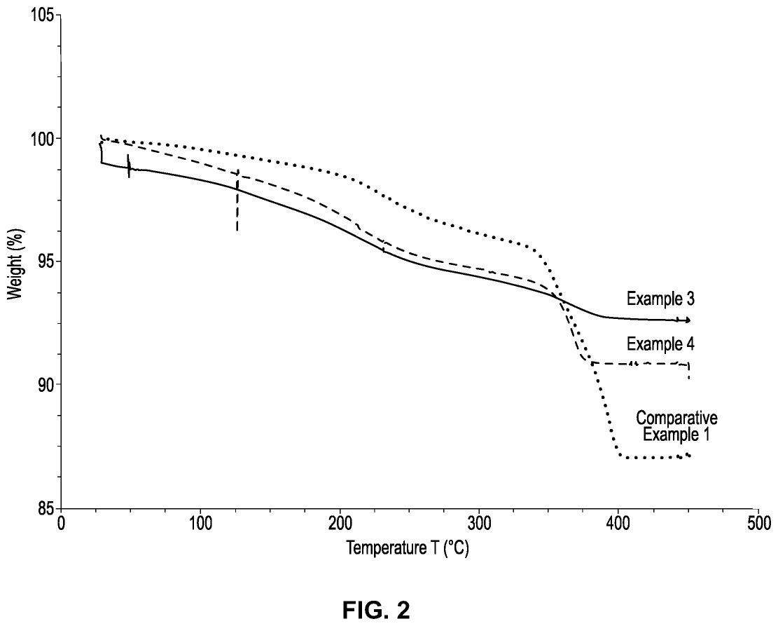

FIG. 2 depicts a thermogravimetric analysis (TGA) of Li₂S material prepared by Example 3, Example 4, and Comparative Example 1. The Li₂S material produced in accordance with these examples and comparative example had been heated under vacuum to 200° C. for 1 hour. The materials were placed in the TGA with flowing Argon where the Li₂S materials were heated to 450° C. at a rate of 5° C./min.

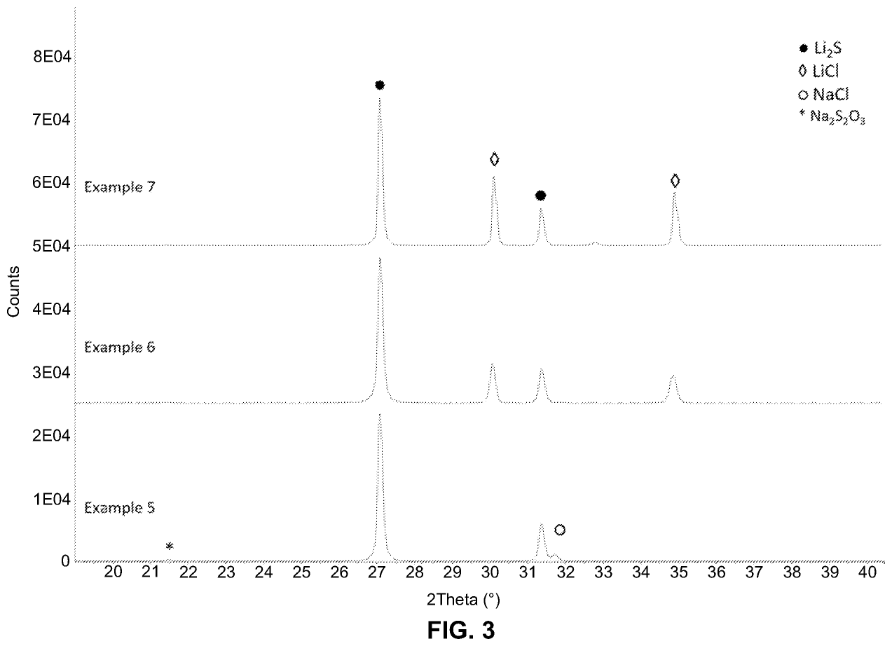

Further provided herein is a composition produced by the methods of the present disclosure comprising Li₂S, NaCl, and NaS₂O₃. The composition has an x-ray diffraction spectrum shown in FIG. 3, labeled Example 5. The peaks of the x-ray diffraction spectrum correspond to Li₂S (2θ=27°, 31.3°), NaCl (31.7°), LiCl (30°, 34.8°), and Na₂S₂O₃ (21.5°, 24.2°, 27.5°, 29°, 41.8°).

Further provided herein is a composition produced by the methods of the present disclosure comprising Li₂S, LiCl, and NaS₂O₃. The composition has an x-ray diffraction spectrum shown in FIG. 3, labeled Example 6. The peaks of the x-ray diffraction spectrum correspond to Li₂S (2θ=27°, 31.3°), LiCl (30°, 34.8°), and Na₂S₂O₃ (21.5°, 24.2°, 27.5°, 29°, 41.8°).

Further provided herein is a composition produced by the methods of the present disclosure comprising Li₂S, LiCl, and NaS₂O₃. The composition has an x-ray diffraction spectrum shown in FIG. 3, labeled Example 7. The peaks of the x-ray diffraction spectrum correspond to Li₂S (2θ=27°, 31.3°), LiCl (30°, 34.8°), and Na₂S₂O₃ (21.5°, 24.2°, 27.5°, 29°, 41.8°).

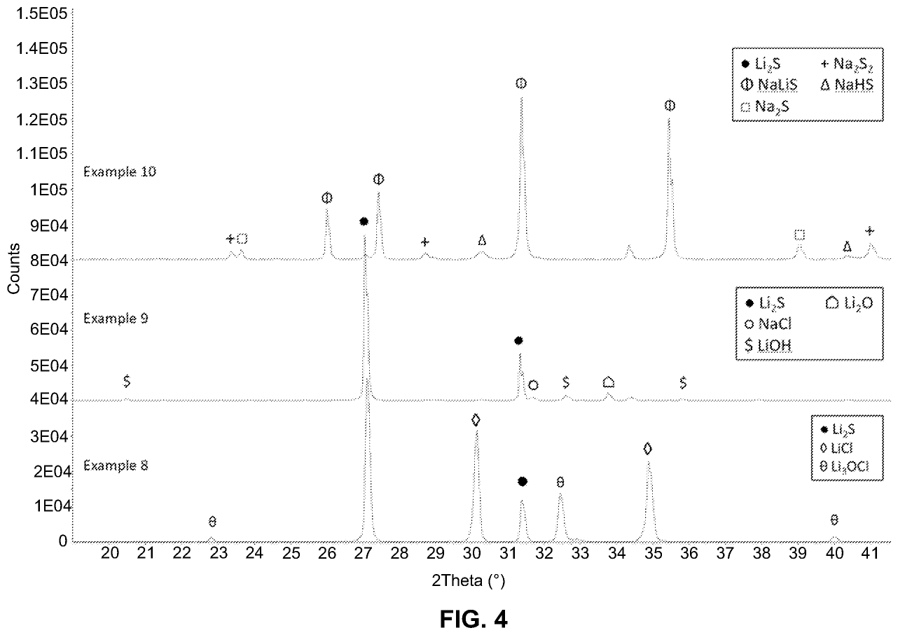

Further provided herein is a composition produced by the methods of the present disclosure comprising Li₂S, LiCl, and Li₃OCl. The composition has an x-ray diffraction spectrum shown in FIG. 4, labeled Example 8. The peaks of the x-ray diffraction spectrum correspond to Li₂S (2θ=27°, 31.3°), LiCl (30°, 34.8°), and Li₃OCl (22.8°, 32.5°, 40°).

Further provided herein is a composition produced by the methods of the present disclosure comprising Li₂S, Li₂O, and LiOH. The composition has an x-ray diffraction spectrum shown in FIG. 4, labeled Example 9. The peaks of the x-ray diffraction spectrum correspond to Li₂S (2θ=27°, 31.3°), LiOH (20.5°, 32.6°, 35.7°), NaCl (31.7°), and Li₂O (33.7°).

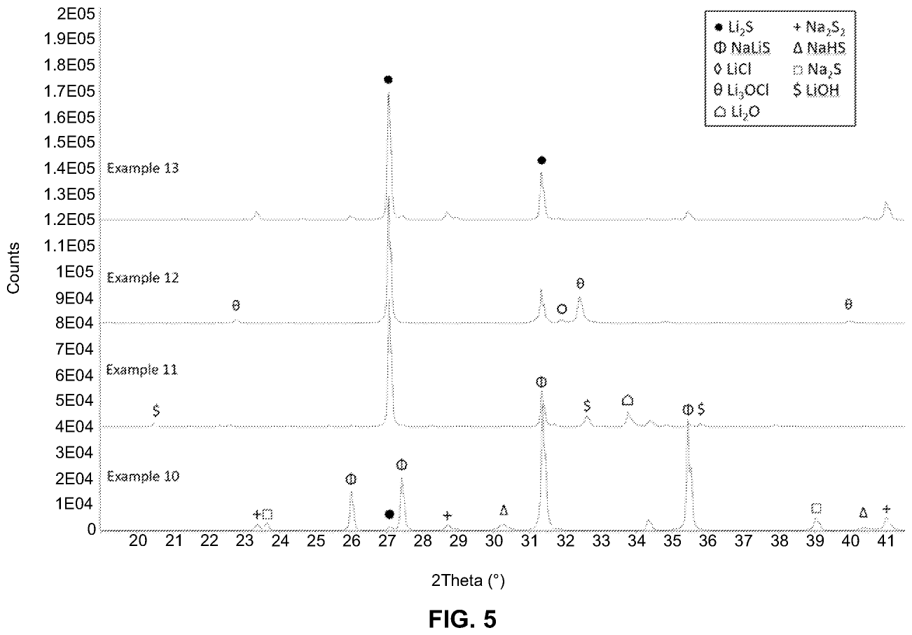

Further provided herein is a composition produced by the methods of the present disclosure comprising NaLiS, Na₂S₂, Na₂S, LiCl, NaHS, Li₂S, and Na₂S₂O₃. The composition has an x-ray diffraction spectrum shown in FIG. 4 and in FIG. 5, labeled Example 10. The peaks of the x-ray diffraction spectrum correspond to Na₂S₂ (2θ=23.3°, 28.8°, 31.9°, 40°40.9°), Na₂S (23.6°, 39°, 46.1°), NaLiS (26°, 27.4°, 31.4°, 35.5°), and NaSH (30.3°, 40.3°).

Further provided herein is a composition produced by the methods of the present disclosure comprising Li₂S, Li₂O, LiOH, LiCl, NaLiS, and NaCl. The composition has an x-ray diffraction spectrum shown in FIG. 5, labeled Example 11. The peaks of the x-ray diffraction spectrum correspond to NaLiS (2θ=26°, 27.4°, 31.4°, 35.5°), LiOH (20.5°, 32.6°, 35.7°), and Li₂O (33.7°).

Further provided herein is a composition produced by the methods of the present disclosure comprising Li₂S, Li₃OCl, LiCl, and NaCl. The composition has an x-ray diffraction spectrum shown in FIG. 5, labeled Example 12. The peaks of the x-ray diffraction spectrum correspond to Li₂S (2θ=27°, 31.3°), LiCl (30°, 34.8°), Li₃OCl (22.8°, 32.5°, 40°), and NaCl (31.7°).

Further provided herein is a composition produced by the methods of the present disclosure comprising Li₂S, Na₂S₂, NaLiS, and β-Na₂S. The composition has an x-ray diffraction spectrum shown in FIG. 5, labeled Example 13. The peaks of the x-ray diffraction spectrum correspond to Li₂S (2θ=27°, 31.3°), NaLiS (26°, 27.4°, 31.4°, 35.5°), and β-Na₂S (24.6°, 28.9°, 35.1°, 40.4°).

The disclosure will now be illustrated with working examples, and which are intended to illustrate the disclosure and not intended to restrict any limitations on the scope of the present disclosure. Unless defined otherwise, all technical and scientific terms used herein have the same meaning as commonly understood to one of ordinary skill in the art to which this disclosure belongs.

### EXAMPLES

### Example 1

0.667 grams anhydrous Na₂S and 0.718 grams of anhydrous NaHS were dissolved in 16 grams of anhydrous ethanol, with less than 50 ppm water, and, separately, approximately 1.09 gram of anhydrous LiCl—the stoichiometric quantity—was dissolved in 6 grams of anhydrous ethanol, with less than 50 ppm water. The LiCl solution was then added into the continuously stirred solution of Na₂S and NaHS at about room temperature (25° C.), wherein a precipitate formed almost immediately. The mixture was cooled to −25° C. then centrifuged for 10 minutes at 4000 rpm in order to separate the supernatant, containing largely Li₂S and LiHS in alcohol, and to remove the insoluble NaCl byproduct. At this point, most of the alcohol was removed from the supernatant using a rotary evaporator at 200° C. under vacuum. At this stage, the material appeared dry but contained approximately 15% bound solvent. The product was further heat treated at 400° C. under argon for 1 hour. This step served to remove the remaining solvent, to convert the LiHS into Li₂S releasing Hydrogen Sulfide gas, and to sinter the Li₂S to the micro-scale.

### Example 2

The experiment was performed in the same manner as in Example 1 except for using 0.75 grams of Na₂S, 0.479 grams of NaHS, and 1.09 grams LiCl.

### Example 3

The experiment was performed in the same manner as in Example 1 except for using 0.8 grams of Na₂S, 0.359 grams of NaHS, and 1.09 grams of LiCl.

### Example 4

The experiment was performed in the same manner as in Example 1 except for using 0.9 grams of Na₂S, 0.144 grams of NaHS, and 1.09 grams LiCl.

### Comparative Example 1

The experiment was performed in the same manner as in Example 1 except for using 1.0 grams of Na₂S, 0.00 grams of NaHS, and 1.09 grams of LiCl.

### Experimental Results

According to Table 1 and FIG. 1, it may be shown that by the process of dissolving an alkali metal salt precursor, a sulfide precursor compound, and a hydrosulfide precursor compound in one or more polar solvents, where there exists a solubility difference between an alkali metal sulfide and an alkali metal salt by-product and a solubility difference between an alkali metal hydrosulfide and an alkali metal salt by-product, that a mixture comprising a soluble lithium sulfide, a soluble lithium hydrosulfide and a precipitated alkali metal salt by-product may be formed. From this mixture, the alkali metal salt by-product is removed, the polar solvent is evaporated forming a mixture containing lithium sulfide and lithium hydrosulfide which is further heated to isolate the lithium sulfide through conversion of the lithium hydrosulfide to lithium sulfide. As the lithium hydrosulfide reaches its decomposition temperature of around 200° C., the material breaks down to form lithium sulfide and hydrogen sulfide gas. When at a temperature of at least 200° C., this hydrogen sulfide gas may aid in the removal of residual solvents that may lead to the formation of undesirable materials.

Table 1 shows that by increasing the amount of hydrosulfide material present, and amount of undesirable oxides species such as LiOCl may be reduced or eliminated. For example, comparing Example 4 to Comparative Example 1, it may be shown that by making a 22.2% molar substituting of Na₂S for NaHS the amount of LiOCl present in the final product drops from 18.8 wt % to 8.3 wt % which is a drop of more than 55%. Comparing Example 1 to Comparative Example 1, it may be shown that by making a 50% molar substitution of Na₂S for NaHS, the amount of LiOCl present in the final product drops from 18.8 wt % to 2.5 wt % which is a drop of more than 86%. This results in a final lithium sulfide material with a purity of 95.2%. By further increasing the amount of alkali metal hydrosulfide incorporated in this process, a lithium sulfide material of ever greater purity may be produced.

From FIG. 2 it may be shown that after being heating at 200° C. for an hour under vacuum, the Li₂S material produced from Comparative Example 1 had a mass loss of 13.12% when heated to 450° C. at 5° C./min in a TGA. A majority of said mass loss starts at around 340° C. and may be attributed to the removal of organic solvent within the Li₂S mixture. After the Li₂S material produced form Example 4 was heated at 200° C. for an hour under vacuum, the Li₂S material had a mass loss of 9.35% when heated to 450° C. at 5° C./min in a TGA. A portion of said mass loss starts at around 345° C. and may be attributed to the decomposition of organic solvent bound to the Li₂S material. Additionally, after the Li₂S material produced form Example 3 was heated at 200° C. for an hour under vacuum, the Li₂S material had a mass loss of 7.5% when heated to 450° C. at 5° C./min in a TGA. A very small portion of said mass loss starts at around 360° C. and may be attributed to the decomposition of organic solvent bound to the Li₂S material. From this data and the information in Table 1, it may be shown that with an increase in the amount of an alkali metal hydrosulfide used in this synthesis method the lower the amount of overall oxide species present in the final Li₂S product. Specifically, Comparative Example 1 uses no alkali metal hydrosulfides in the synthesis and has a 13.12% mass loss in TGA and contains 18.8% Li₃OCl. Example 4 incorporates NaHS to the effect of a 9:2 molar ratio of Na₂S:NaHS, has a mass loss of 9.35% and contains 8.4% Li₃OCl. In Example 3 the mass loss and Li₃OCl content is further reduced by increasing the hydrosulfide content within the synthesis. In this example, NaHS is incorporated to the effect of a 4:2 molar ratio of Na₂S:NaHS, has a mass loss of 7.5% and contains 3.4% Li₃OCl.

### Example 5

16 g of ethanol was added to a 20 mL vial containing a small magnetic stir bar. 0.8717 g of anhydrous LiCl was added to the ethanol where the solution was stirred and heated to 78° C. After 15 minutes, a mixture of 0.313 g of NaSH containing 24% by mass water in the form of a hydrate and 0.666 g of Na₂S containing less than 300 ppm water was added to the hot ethanol-LiCl solution, wherein a precipitate formed almost immediately. The mixture was then left to stir over night (16-18 hours) while being held at a constant temperature of 78° C. After the 16-18 hours had elapsed, the mixture was then poured into a centrifuge tube and placed in a −25° C. freezer for about one hour to encourage more precipitation. After around an hour, the mixture was centrifuged for 10-15 minutes at 4000 rpm, then placed back in the −25° C. freezer for an additional 30 minutes. After 30 minutes, the mixture was centrifuged for another 5 minutes, then placed back in the −25° C. freezer for at least 30 minutes. After 30 minutes, the mixture was poured into an evapratory flask. The filtered solution was then heated to a temperature around 250° C. while under vacuum conditions for around 1 hour. The dried solids were then heated to a temperature of around 450° C. for about 15 minutes.

The material produced in Example 5 was 94.4% Li₂S, 3.9% NaCl, and 1.7% Na₂S₂O₃. An x-ray diffractogram of the material is shown in FIG. 3. The X-ray diffraction measurement was taken with Cu-Kα(1,2)=1.54064 Å. The XRD spectra of the material produced by Example 5 shows evidence of Li₂S (2θ=27°, 31.3°), NaCl (31.7°), LiCl (30°, 34.8°), and Na₂S₂O₃ (21.5°, 24.2°, 27.5°, 29°, 41.8°).

Surprisingly, a 94.4% pure Li₂S material was produced using a NaHS•H₂O material that contained 24% water by mass. Moreover, the NaCl and Na₂SO₃ are not appreciably soluble in alcohols. It is therefore believed that these impurities may be removed using improved filtering techniques to result in a Li₂S compound having 99%+purity.

### Example 6

Example 6 was carried out in the same manner as Example 5 except the amount of precursors were increased to 15.024 g NaHS containing 24% by mass water, 31.968 g Na₂S with 300 ppm water, and 52 g anhydrous LiCl. The amount of Ethanol used was increased to 1000 ml.

The material produced in Example 6 was a composite Li₂S—LiCl material containing 77% Li₂S, 21.1% LiCl, and 1.9% Na₂S₂O₃. An x-ray diffractogram of the material is shown in FIG. 3. The X-ray diffraction measurement was taken with Cu-Kα(1,2)=1.54064 Å. The XRD spectra of the material produced by Example 6 shows evidence of Li₂S (2θ=27°, 31.3°), LiCl (30°, 34.8°), and Na₂S₂O₃ (21.5°, 24.2°, 27.5°, 29°, 41.8°).

Importantly, the composite Li₂S—LiCl material was formed without the formation of Li₃OCl, which is not possible when only Na₂S is used.

### Example 7

Example 7 was carried out in the same manner as Example 5 except anhydrous LiCl was used in the amount of 1.2 g. The material produced in Example 7 was a composite Li₂S— LiCl material containing 66% Li₂S, 33% LiCl, and 1% Na₂S₂O₃. An x-ray diffractogram of the material is shown in FIG. 3. The X-ray diffraction measurement was taken with Cu-Kα(1,2)=1.54064 Å. The XRD spectra of the material produced by Example 7 shows evidence of Li₂S (2θ=27°, 31.3°), LiCl (30°, 34.8°), and Na₂S₂O₃ (21.5°, 24.2°, 27.5°, 29°, 41.8°).

Importantly, the composite Li₂S—LiCl material was formed without the formation of Li₃OCl, which is not possible when only Na₂S is used. For comparison, see Example 8 below wherein Li₃OCl was formed. This example also demonstrates the ability to tune the ratio of Li₂S to LiCl by adjusting the amount of each precursor used in the reaction.

### Example 8

Example 8 was carried out in the same manner as Example 5 except 1.5 g of NaS•H3H₂O containing about 50% water by mass and 0.4950 g of NaSH•H₂O containing 24% by mass water was used. Additionally, the amount of LiCl used was increased to 1.0896 g. The total amount of water that was introduced into the reaction was 1.005 g and the weight ratio of NaSH to total water was 0.49:1. The weight ratio of NaSH to LiCl was 0.45:1. The material produced in Example 8 was 47.5% Li₂S, 34.2% LiCl, and 16.1% Li₃OCl, and 2.2% other. An x-ray diffractogram of the material is shown in FIG. 4. The X-ray diffraction measurement was taken with Cu-Kα(1,2)=1.54064 Å. The XRD spectra of the material produced by Example 8 shows evidence of Li₂S (2θ=27°, 31.3°), LiCl (30°, 34.8°), and Li₃OCl (22.8°, 32.5°, 40°).

### Example 9

Example 9 was carried out in the same manner as Example 8 except 2.0 g of NaSH•3H₂O containing about 50% by mass water and 0.660 g of NaSH•H₂O containing 24% by mass water was used. The total amount of water that was introduced into the reaction was 1.345 g and the weight ratio of NaSH to total water was 0.49:1. The weight ratio of NaSH to LiCl was 0.6:1. The material produced in Example 9 was 78.4% Li₂S, 9.4% Li₂O, 9.9% LiOH, and 2.3% other. An x-ray diffractogram of the material is shown in FIG. 4. The X-ray diffraction measurement was taken with Cu-Kα(1,2)=1.54064 Å. The XRD spectra of the material produced by Example 9 shows evidence of Li₂S (2θ=27°, 31.3°), LiOH (20.5°, 32.6°, 35.7°), NaCl (31.7°), and Li₂O (33.7°).

### Example 10

Example 10 was carried out in the same manner as Example 8 except 4.3664 g of NaSH•3H₂O containing around 50% by mass water was 0.1.4409 g of NaSH•H₂O containing 24% by mass water was used. The total amount of water that was introduced into the reaction was 2.9255 g and the weight ratio of NaSH to total water was 0.49:1. The weight ratio of NaSH to LiCl was 1:0.76. The material produced in Example 10 was 82.1% NaLiS, 8.8% Na₂S₂, and 3.6% Na₂S, 1.8% LiCl, 1.5% NaHS, 1.2% Li₂S, and 1% Na₂S₂O₃. An x-ray diffractogram of the material is shown in FIG. 4 and in FIG. 5. The X-ray diffraction measurement was taken with Cu-Kα(1,2)=1.54064 Å. The XRD spectra of the material produced by Example 10 shows evidence of Na₂S₂ (2θ=23.3°, 28.8°, 31.9°, 40°, 40.9°), Na₂S (23.6°, 39°, 46.1°), NaLiS (26°, 27.4°, 31.4°, 35.5°), and NaSH (30.3°, 40.3°).

### Example 11

Example 11 was carried out in the same manner as Example 10 except the 4.3664 g of NaSH•3H₂O containing 54% by mass water was replaced with 0.313 g NaSH•H₂O containing 24% by mass water, 0.9517 g Na₂S•xH₂O, and 0.2746 g of Na₂S containing 300 ppm water. The total amount of water that was introduced into the reaction was 0.48 g and the weight ratio of NaSH to total water was 0.49:1. The material produced in Example 11 was 57% Li₂S, 17.9% Li₂O, 19.5% LiOH, 3.4% NaLiS, 1.1% NaCl, and 1.1% other. An x-ray diffractogram of the material is shown in FIG. 5. The X-ray diffraction measurement was taken with Cu-Kα(1,2)=1.54064 Å. The XRD spectra of the material produced by Example 11 shows evidence of NaLiS (2θ=26°, 27.4°, 31.4°, 35.5°), LiOH (20.5°, 32.6°, 35.7°), and Li₂O (33.7°).

### Example 12

Example 12 was carried out in the same manner as Example 10 except two changes were made. First, the 4.3664 g of NaSH•3H₂O containing 54% by mass water was replaced with 0.313 g NaSH•H₂O containing 24% by mass water and 0.666 g of Na₂S containing 300 ppm water. Second, 0.56 ml of DI water was added to the Ethanol prior to synthesis. The total amount of water that was introduced into the reaction was 0.48 g and the weight ratio of NaSH to total water was 0.49:1. The material produced in Example 12 was 79.6% Li₂S, 18.6% Li₃OCl, 1.4% NaCl, and 0.5% LiCl. An x-ray diffractogram of the material is shown in FIG. 5. The X-ray diffraction measurement was taken with Cu-Kα(1,2)=1.54064 Å. The XRD spectra of the material produced by Example 12 shows evidence of Li₂S (2θ=27°, 31.3°), LiCl (30°, 34.8°), Li₃OCl (22.8°, 32.5°, 40°), and NaCl (31.7°).

### Example 13

Example 13 was carried out in the same manner as Example 10 except 1.8959 g NaSH•H₂O containing 24% water by mass was mixed with 0.27 ml of DI water to adjust the waters of hydration from 1 to 2 (NaSH•2H₂O). This newly hydrated NaSH was then used to replace the 4.3664 g of NaSH containing 54% by mass water. The total amount of water that was introduced into the reaction was 0.725 g and the weight ratio of NaSH to total water was 1:0.5. The material produced in Example 13 was 68% Li₂S, 15.4% Na₂S₂, 13.2% NaLiS, and 3.3% β-Na₂S. An x-ray diffractogram of the material is shown in FIG. 5. The X-ray diffraction measurement was taken with Cu-Kα(1,2)=1.54064 Å. The XRD spectra of the material produced by Example 13 shows evidence of Li₂S (2θ=27°, 31.3°), NaLiS (26°, 27.4°, 31.4°, 35.5°), and β-Na₂S (24.6°, 28.9°, 35.1°, 40.4°).

In contrast to Example 11 where water was introduced in the form of a sulfide hydrate and Example 12 where water was introduced in the form of an ethanol-water solvent blend to simulate aqueous conditions, which both resulted in the formation of lithium-oxygen containing species (Li₂O, LiOH, Li₃OCl), water was added in Example 13 directly to a NaSH material. This resulted in a material that was substantially free of oxides. It was therefore concluded that water could be introduced into the system in the form of a hydrosulfide hydrate to produce a material substantially free of oxides.

### Example 14

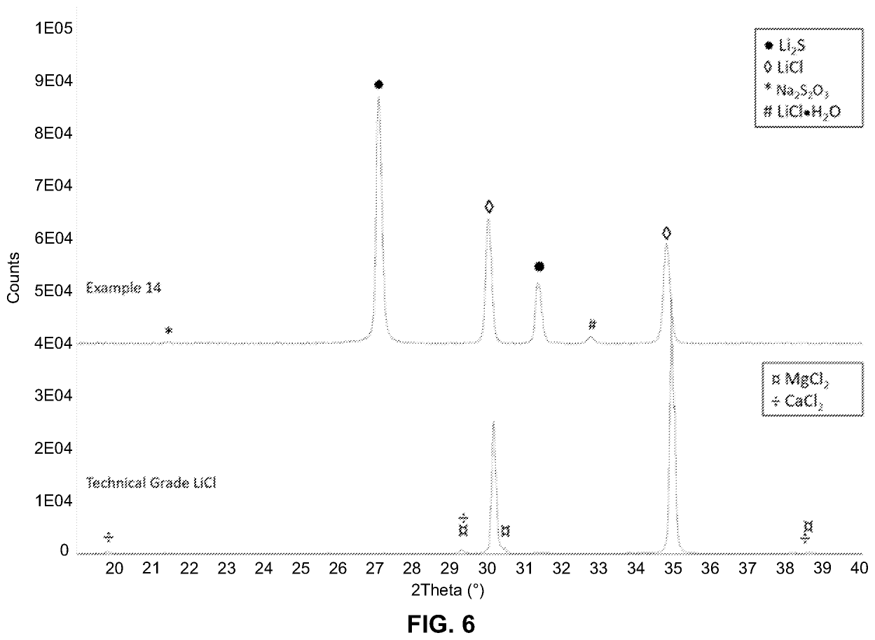

Example 14 was carried out in the same manner as Example 5 except that 1.1469 g of Technical Grade LiCl (95% LiCl, 2.5% MgCl₂, 2.5% CaCl₂) was used. The Technical Grade LiCl was produced by hand mixing a composite of 3.8 g LiCl, 0.1 g MgCl₂, and 0.1 g CaCl₂) producing a mixture that was 95% wt LiCl, 2.5% wt MgCl₂, and 2.5% wt CaCl₂. The materials were hand mixed using a mortar and pestle. The material resulting from Example 14 was 63.3% Li₂S, 34.8% LiCl, and 1.8% Na₂S₂O₃. An x-ray diffractogram of the material produced in Example 14 and the Technical Grade LiCl is shown in FIG. 6. The X-ray diffraction measurement was taken with Cu-Kα(1,2)=1.54064 Å. The XRD spectra of the material produced by Example 14 shows evidence of Li₂S (2θ=27°, 31.3°), LiCl (30°, 34.8°), and Na₂S₂O₃ (21.5°, 24.2°, 27.5°, 29°, 41.8°). The XRD spectra of the Technical Grade LiCl material shows evidence of LiCl (2θ=30°, 34.8°), MgCl₂ (29.3°, 30.5°, 38.7°), and CaCl₂ (19.8°, 29.3°, 38.6°, 40.2°).

The Technical Grade LiCl material contains contaminates normally found in what industry would call Technical Grade LiCl. These MgCl₂ and CaCl₂ impurities are difficult to remove and requires specialized ion exchange systems to do so, which is an artifact of the impurities' high solubility in polar solvents such as water and alcohols. The process of the present disclosure converts the highly soluble MgCl₂ and CaCl₂ into their corresponding sulfides, MgS and CaS, which are substantially insoluble in alcohols. Due to their low solubility in ethanol, the impurities could be removed via filtering. Thus, LiCl of lower purity may be used to produce a Li₂S material or Li₂S—LiCl composite devoid of such Mg and Ca containing impurities.

### Example 15

Example 15 was carried out in the same manner as Example 5 except the masses of the precursors were changed to 0.1569 g NaHS containing 24% water by mass, 0.333 g Na₂S containing 300 ppm water, and anhydrous 0.5448 g LiCl. Additionally, 0.2 g of Technical Grade Li₂S (91% Li₂S, 4.5% Li₂SO₄, and 4.5% Li₂CO₃) was added to the ethanol along with the NaHS and the Na₂S. The Technical Grade Li₂S was produced by mixing 99% Li₂S with Li₂SO₄ and Li₂CO₃ in the ratio of 91% wt Li₂S, 4.5% wt Li₂SO₄ and 4.5% wt Li₂CO₃. The materials were hand mixed using a mortar and pestle.

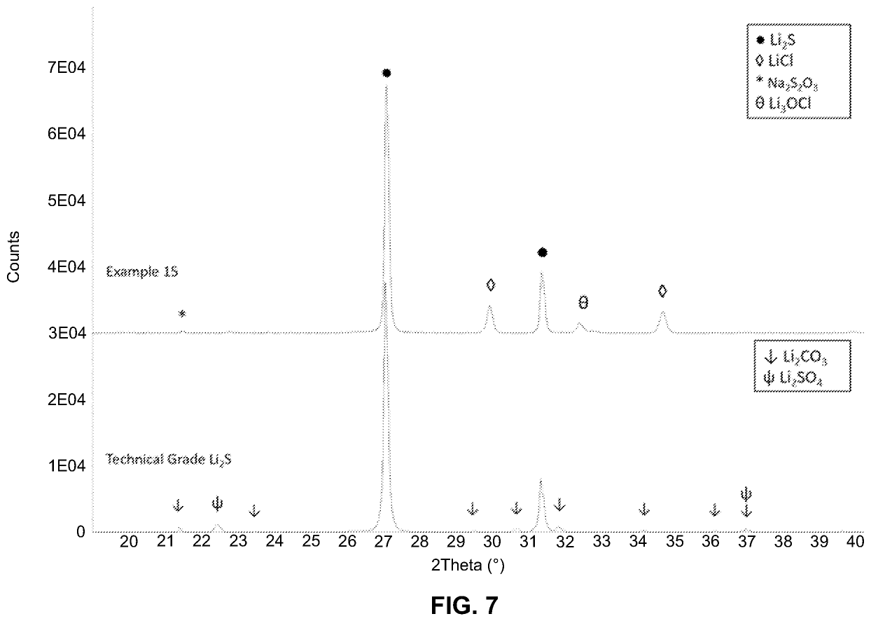

An x-ray diffractogram of the material produced in Example 15 and the Technical Grade Li₂S is shown in FIG. 7. The X-ray diffraction measurement was taken with Cu-Kα(1,2)=1.54064 Å. The XRD spectra of the material produced by Example 15 shows evidence of Li₂S (2θ=27°, 31.3°), LiCl (30°, 34.8°), and Li₃OCl (22.8°, 32.5°, 40°). The XRD spectra of the Technical Grade Li₂S material shows evidence of Li₂S (2θ=27°, 31.3°), Li₂CO₃ (21.3°, 23.5°, 29.5°, 30.6°, 31.8°, 34.1°, 36.1°, 37°, 39.5°, 39.9°), and Li₂SO₄ (22.4°, 26°, 37°). The absence of the Li₂CO₃ and Li₂SO₄ in the final product of Example 15 demonstrates that Technical Grade Li₂S with impurities such as lithium-oxygen species can be introduced into the reaction and removed from the final product.

### Example 16

Precursors including 11.1051 g of the Li₂S—LiCl composite made in Example 6, 8.2902 g P₂S₅ (Sigma-Aldrich Co.), and 0.7157 g LiCl (Sigma-Aldrich Co.) were added to a 250 ml zirconia milling jar with zirconia milling media and compatible solvent (e.g. xylenes or heptane). The mixture is milled in a Retsch PM 100 planetary mill for 12 hours at 500 RPM. The material is collected and dried at 140° C. in an inert (argon or nitrogen) environment for 2 hours. The resulting solid electrolyte powder (Li₆PS₅Cl) was then heated to a temperature of around 400° C. for around 30 minutes.

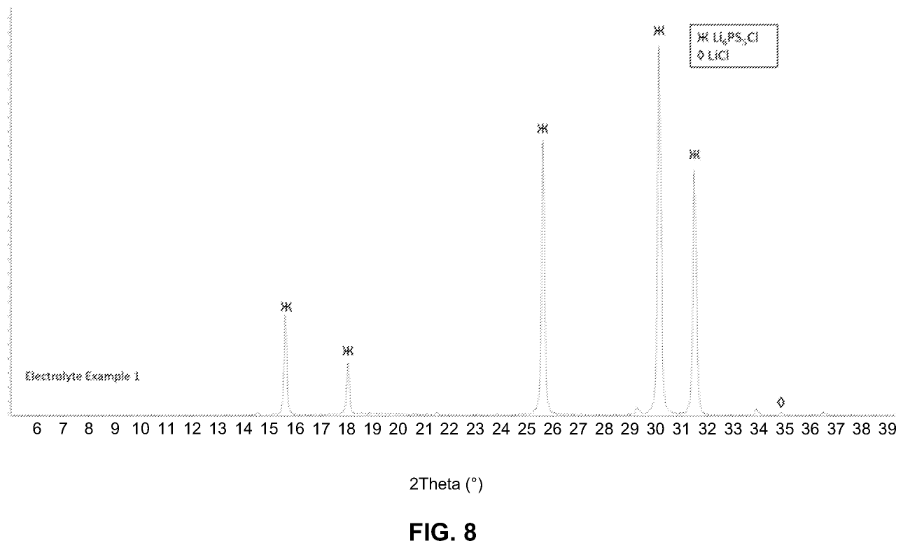

An x-ray diffractogram of the material produced in Example 16 is shown in FIG. 8. The X-ray diffraction measurement was taken with Cu-Kα(1,2)=1.54064 Å.

The room temperature (25° C.) Ionic conductivity of this material was 2.2 mS.

These results demonstrate that a sulfide solid electrolyte with a high ionic conductivity (i.e., greater than 2 mS) can be synthesized using a Li₂S—LiCl composite produced by the methods described herein.

### Example 17

A thermogravimetric analysis (TGA) was performed comparing the material synthesized in Example 5 and the material synthesized in Comparative Example 1. The TGA data labeled Example 5 was produced by taking an aliquot of material from Example 5 and heating it to no more than 100° C. for 1 hour. The material was then placed into the TGA and heated to 450° C. at a ramp rate of 5° C./min. The TGA data labeled Comparative Example 1-100° C. was produced by taking an aliquot of material from Comparative Example 1 and heating it to no more than 100° C. for 1 hour. The material was then placed into the TGA and heated to 450° C. at a ramp rate of 5° C./min. The TGA data labeled Comparative Example 1-250° C. was produced by taking an aliquot of material from Comparative Example 1 and heating it to no more than 250° C. for 1 hour. The material was then placed into the TGA and heated to 450° C. at a ramp rate of 5° C./min. The data are shown in FIG. 9. The material labeled Comparative Example 1-100° C. had a mass loss of 43.9%, the material labeled Comparative Example 1-250° C. had a mass loss of 19.66%, and the material labeled Example 5 has a mass loss of 8.0%.

By comparing Example 5 to Comparative Example 1-100° C., it can be demonstrated that when using a hydrated hydrosulfide material such as NaSH•xH₂O in the synthesis process, solvents such as ethanol can be removed at lower temperatures as compared to a synthesis using only a metal sulfide such as Na₂S. Specifically, Example 5 and Comparative Example 1-100° C. were both heated under the same conditions (100° C.), but Example 5 only had a 8% mass loss whereas Comparative Example 1-100° C. had a mass loss of 43.9%. This corresponds to an 82% reduction in the amount of solvent bound to the Li₂S material after being heated to 100° C. The removal of solvent at lower temperatures lowers the possibility of forming oxygen or carbon containing species.

FIG. 10 shows a FTIR spectrum of the materials produced in Example 5 and in Comparative Example 1. The top spectra (red) was generated by taking an aliquot of Comparative Example 1 that had been heated it to no more than 100° C. The spectra second from the top (green) was generated by taking an aliquot of Example 5 that had been heated it to no more than 100° C. The spectra third from the top (purple) was generated by taking an aliquot of Example 5 that had been heated it to no more than 250° C. The spectra third from the top (purple) was generated by taking an aliquot of Example 5 that had been heated it to no more than 200° C.

Features described above as well as those claimed below may be combined in various ways without departing from the scope hereof. The previous examples illustrate some possible, non-limiting combinations. It should thus be noted that the matter contained in the above description or shown in the accompanying drawings should be interpreted as illustrative and not in a limiting sense. Accordingly, many combinations, permutations, variations and modifications of the foregoing embodiments of disclosures not set forth explicitly herein will nevertheless fall within the scope of such disclosures.

We claim:

1. A method for producing a water-reactive alkali metal sulfide comprising:
(a) reacting a first alkali metal salt and a first alkali metal hydrosulfide and optionally a first sulfide in a polar solvent to produce a mixture comprising a second sulfide and a second alkali metal salt precipitate, wherein the first alkali metal salt comprises an alkali or alkali earth metal impurity and the impurity is not lithium;
(b) removing the precipitated second alkali metal salt from the mixture to produce a supernatant comprising the second sulfide and the polar solvent; and,
(c) removing the polar solvent from the supernatant to produce a second sulfide.

2. The method of claim 1, wherein the first alkali metal salt comprises an alkali or alkali earth metal impurity selected from the group consisting of sodium, magnesium, potassium, calcium, or a combination thereof.

3. The method of claim 1, wherein the first alkali metal salt comprises lithium and an alkali or alkali earth metal impurity selected from the group consisting of sodium, magnesium, potassium, calcium, or a combination thereof.

4. The method of claim 1, wherein the second sulfide is at least 90% free of alkali metal or alkali earth metal impurities.

5. The method of claim 1, wherein the second sulfide is at least 95% free of alkali metal or alkali earth metal impurities.

6. The method of claim 1, wherein the second sulfide is at least 98% free of alkali metal or alkali earth metal impurities.

7. The method of claim 1, wherein the second sulfide is at least 99% free of alkali metal or alkali earth metal impurities.

8. The method of claim 1, wherein the second sulfide is at least 99.5% free of alkali metal or alkali earth metal impurities.

9. The method of claim 1, wherein the second sulfide is at least 99.9% free of alkali metal or alkali earth metal impurities.

10. The method of claim 1, wherein the removing the polar solvent from the supernatant comprises evaporating the polar solvent to produce a powder.

11. The method of claim 10, wherein the evaporating comprises drying the powder to remove substantially all of the polar solvent.

12. The method of claim 10, wherein over 99% by weight of the polar solvent from the powder is removed.

13. The method of claim 10, wherein over 80% by weight of the polar solvent from the powder is removed.

14. The method of claim 10, wherein the removing the polar solvent comprises spray drying, rotary drying, tray drying, fluidized bed drying, vacuum drying, or a combination thereof.

15. The method of claim 1, further comprising adding a sulfur source to increase the purity of the second sulfide.

16. The method of claim 14, wherein the sulfur source comprises one or more of elemental sulfur and H₂S.

17. The method of claim 1, wherein the second sulfide is at least 95% pure by weight.

18. The method of claim 1, wherein the second sulfide is at least 98% pure by weight.

19. The method of claim 1, wherein the second sulfide is at least 99% pure by weight.

20. The method of claim 1, wherein the second sulfide is at least 99.5% pure by weight.

21. The method of claim 1, wherein the supernatant further comprises a second alkali metal hydrosulfide.

22. The method of claim 20, wherein the second alkali metal hydrosulfide produces the second sulfide and hydrogen sulfide.

23. The method of claim 20, wherein the second alkali metal hydrosulfide comprises LiHS.

24. The method of claim 1, further comprising adding an anti-solvent compound to the supernatant.

25. The method of claim 23, wherein the anti-solvent comprises a hydrocarbon-based solvent, a non-polar solvent, or combinations thereof.

26. The method of claim 1, wherein removing the second alkali metal salt from the supernatant comprises at least one of centrifuging, filtering, gravity settling, and cooling.

27. The method of claim 1, wherein the polar solvent is substantially anhydrous.

28. The method of claim 1, wherein the first alkali metal hydrosulfide is substantially anhydrous.

29. The method of claim 1, wherein the polar solvent comprises at least one alcohol selected from the group consisting of ethanol, 1-propanol, 1-butanol, and mixtures thereof.

30. The method of claim 1, wherein the first alkali metal salt comprises LiCl, the first alkali metal hydrosulfide comprises NaHS, and the first sulfide comprises Na₂S.

31. The method of claim 1, wherein the second alkali metal salt comprises NaCl and the second sulfide comprises Li₂S.

32. The method of claim 1, wherein the optional first sulfide is selected from the group consisting of K₂S, Na₂S, (NH₄)₂S, and mixtures thereof.

33. The method of claim 1, wherein the first alkali metal hydrosulfide compound is selected from the group consisting of KHS, NaHS, LiHS, and mixtures thereof.

34. The method of claim 1, wherein the optional first sulfide comprises Li₂S.

35. The method of claim 1, wherein the second sulfide comprises Li₂S.

34. A method for producing a water-reactive alkali metal sulfide comprising:
(a) reacting a first alkali metal salt and a first alkali metal hydrosulfide and a first sulfide in a polar solvent to produce a mixture comprising a second sulfide and a second alkali metal salt precipitate, wherein the first sulfide comprises an impurity selected from the group consisting of an oxygen impurity, halide impurity, or a combination thereof;
(b) removing the precipitated second alkali metal salt from the mixture to produce a supernatant comprising the second sulfide and the polar solvent; and,
(c) removing the polar solvent from the supernatant to produce a second sulfide.

35. The method of claim 34, wherein the first sulfide comprises a halide impurity selected from the group consisting of chloride, bromide, iodide, fluoride, or a combination thereof.

36. The method of claim 34, wherein the first sulfide comprises an oxygen impurity selected from the group consisting of a carbonate, sulfate, hydroxide, oxide, or combination thereof.

36. The method of claim 34, wherein the second sulfide is at least 90% free of impurity.

37. The method of claim 34, wherein the second sulfide is at least 95% free of impurity.

38. The method of claim 34, wherein the second sulfide is at least 98% free of impurity.

39. The method of claim 34, wherein the second sulfide is at least 99% free of impurity.

40. The method of claim 34, wherein the second sulfide is at least 99.5% free of impurity.

41. The method of claim 34, wherein the second sulfide is at least 99.9% free of impurity.

42. A method for producing a water-reactive alkali metal sulfide comprising:
(a) reacting a first alkali metal salt and a first sulfide in a polar solvent to produce a mixture comprising a second sulfide and a second alkali metal salt precipitate;
(b) removing the precipitated second alkali metal salt from the mixture to produce a supernatant comprising the second sulfide and the polar solvent; and,
(c) removing the polar solvent from the supernatant to produce a second sulfide.

43. A method for producing a water-reactive alkali metal sulfide comprising:
(a) reacting a first alkali metal salt and a first alkali metal hydrosulfide in a polar solvent to produce a mixture comprising a sulfide and a second alkali metal salt precipitate, wherein the first alkali metal salt comprises an alkali or alkali earth metal impurity and the impurity is not lithium;
(b) removing the precipitated second alkali metal salt from the mixture to produce a supernatant comprising sulfide and the polar solvent; and,
(c) removing the polar solvent from the supernatant to produce the sulfide.

44. A method for producing a water-reactive alkali metal sulfide comprising:
(a) reacting a first alkali metal salt and a first alkali metal hydrosulfide and optionally a first sulfide in a polar solvent to produce a mixture comprising a second sulfide and a second alkali metal salt, wherein the first alkali metal salt comprises an alkali or alkali earth metal impurity and the impurity is not lithium; and
(b) removing the polar solvent to isolate the second sulfide and/or the second alkali metal salt.

45. The method of claim 44, wherein the first alkali metal salt comprises lithium and an alkali or alkali earth metal impurity selected from the group consisting of sodium, magnesium, potassium, calcium, or a combination thereof.

46. The method of claim 44, wherein the second sulfide is at least 90% free of alkali metal or alkali earth metal impurities.

47. The method of claim 44, wherein the second sulfide is at least 95% free of alkali metal or alkali earth metal impurities.

48. The method of claim 44, wherein the second sulfide is at least 98% free of alkali metal or alkali earth metal impurities.

49. The method of claim 44, wherein the second sulfide is at least 99% free of alkali metal or alkali earth metal impurities.

50. The method of claim 44, wherein the second sulfide is at least 99.5% free of alkali metal or alkali earth metal impurities.

51. A method for producing a water-reactive alkali metal sulfide comprising:
(a) reacting a first alkali metal salt and a first alkali metal hydrosulfide and optionally a first sulfide in a polar solvent to produce a mixture comprising a second sulfide and a second alkali metal salt precipitate, wherein the first alkali metal salt comprises an alkali or alkali earth metal impurity and the impurity is not lithium;
(b) removing the precipitated second alkali metal salt and optionally one or more alkaline earth metal sulfides from the mixture to produce a supernatant comprising the second sulfide and the polar solvent; and,
(c) removing the polar solvent from the supernatant to produce a second sulfide.

52. A method for producing a water-reactive alkali metal sulfide comprising:
(a) reacting a first alkali metal salt and a first alkali metal hydrosulfide and optionally a first sulfide in a polar solvent to produce a mixture comprising a second sulfide, a second alkali metal salt, a third sulfide and the first alkali metal salt, wherein the first alkali metal salt comprises an alkali or alkali earth metal impurity and the impurity is not lithium; and
(b) removing the precipitated second alkali metal salt and the precipitated third sulfide;
(c) removing the polar solvent to isolate the second sulfide and/or the first alkali metal salt.
